(19) United States
(12) Patent Application Publication
(10) Pub. No.: US 2026/0300302 A1
(43) Pub. Date: Oct. 1, 2026

(54) DYNAMIC CONTENT WINDOW BASED ON CONTEXT

(71) Applicant: Pansynapse Inc., Riverside, CA (US)

(72) Inventors: Pascal Ralph Manfred Simpkins, Costa Mesa, CA (US); Kyle Hendershot, Sherman Oaks, CA (US)

(21) Appl. No.: 19/282,732

(22) Filed: Jul. 28, 2025

Related U.S. Application Data
(60) Provisional application No. 63/777,214, filed on Mar. 25, 2025.

(51) Int. Cl. G06F 16/2457; G06F 16/22; G06F 16/901

(52) U.S. Cl. CPC G06F 16/24575; G06F 16/2237; G06F 16/9024

(57) ABSTRACT

A computer system that determines a dynamic content window is described. During operation, the computer system receives, from an electronic device, an input vector. Then, the computer system accesses, in a graph database (such as a vector graph database), information specifying a context associated with the input vector. Moreover, the computer system determines a dynamic content window based at least in part on the context, where the dynamic content window specifies a subset of content in the input vector, and the dynamic content window has a length less than a predefined value. Next, the computer system provides, to a pretrained neural network, the input vector and the dynamic content window. Furthermore, the computer system receives, from the pretrained neural network, a response vector, and provides, addressed to the electronic device, the response vector.

### CROSS-REFERENCE TO RELATED APPLICATIONS

This application claims priority under 35 U.S.C. 119(e) to U.S. Provisional Application Ser. No. 63/777,214, “Dynamic Content Window Based on Context,” filed on Mar. 25, 2025, by Pascal Ralph Manfred Simpkins, et al., the contents of which are herein incorporated by reference.

### STATEMENT REGARDING FEDERALLY SPONSORED RESEARCH OR DEVELOPMENT

Not Applicable.

### FIELD

The described embodiments relate to dynamically adapting a length of a content window for a pretrained neural network based at least in part on a context associated with an input vector to the pretrained neural network.

### INTRODUCTION

Advances in neural networks (which are sometimes referred to as ‘artificial neural networks’) have led to their widespread adoption in a variety of applications. For example, convolutional network networks (CNNs) are routinely used for processing information, such as for image processing.

In a typical application of a pretrained neural network for image processing, a content window is often used to facilitate the identification of objects patterns or features in an image. A ‘content window’ usually refers to a sliding window that is slide across an image. Moreover, a CNN is used to analyze the content (such as the pixels) within the content window.

Usually, a content window has a fixed size or length (such as a predefined box or set of pixels). However, this architecture typically adversely impacts the performance of CNNs and, more generally, pretrained neural networks. In particular, fixed content windows often have a large size. In turn, this results in large memory and processing requirements, with commensurate impact on power consumption and analysis time. Consequently, the use of a fixed content window often adversely impacts the performance of pretrained neural networks.

### SUMMARY

A computer system that determines a dynamic content window is described. This computer may include: an interface circuit that communicates with an electronic device; a computation device (such as a processor, a graphics processing unit or GPU, etc.) that executes program instructions; and memory that stores the program instructions. During operation, the computer system receives, from the electronic device, an input vector. Then, the computer system accesses, in a graph database, information specifying a context associated with the input vector. Moreover, the computer system determines a dynamic content window based at least in part on the context, where the dynamic content window specifies a subset of content in the input vector, and the dynamic content window has a length less than a predefined value. Next, the computer system provides, to a pretrained neural network, the input vector and the dynamic content window. Furthermore, the computer system receives, from the pretrained neural network, a response vector, and provides, addressed to the electronic device, the response vector.

Note that the graph database (or data structure) may include a vector graph database.

Moreover, the pretrained neural network may include a large language model (LLM).

Furthermore, during operation, the computer system may update, in the graph database, the context based at least in part on the input vector and the response vector.

Additionally, the input vector may correspond to: software code, a portion of a narrative, or a portion of a conversation between an individual and the pretrained neural network.

In some embodiments, the predefined value may be less than or equal to 8,095 tokens. Alternatively or additionally, the predefined value may be significantly smaller than 128,000 tokens.

Moreover, the dynamic content window may correspond to a next operation or operation in an interaction between the electronic device and the pretrained neural network.

Furthermore, the pretrained neural network may be implemented using a second computer system, where the second computer system is different from the computer system.

Additionally, the response vector may be based at least in part on the input vector and the dynamic content window.

In some embodiments, the pretrained neural network may include one or more convolutional layers, one or more residual layers and one or more dense layers. Note that a given node in a given layer in the pretrained neural network may include an activation function that includes: a rectified linear activation function (ReLU), a leaky ReLU, an exponential linear unit (ELU) activation function, a parametric ReLU, a tanh activation function, and/or a sigmoid activation function.

Another embodiment provides a computer for use, e.g., in the computer system.

Another embodiment provides a computer-readable storage medium for use with the computer or the computer system. When executed by the computer or the computer system, this computer-readable storage medium causes the computer or the computer system to perform at least some of the aforementioned operations.

Another embodiment provides a method, which may be performed by the computer or the computer system. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### DRAWINGS

FIG. 1 is a block diagram illustrating an example of a computer system in accordance with an embodiment of the present disclosure.

FIG. 2 is a flow diagram illustrating an example of a method for determining a dynamic content window using a computer system in FIG. 1 in accordance with an embodiment of the present disclosure.

FIG. 3 is a drawing illustrating an example of communication between components in a computer system in FIG. 1 in accordance with an embodiment of the present disclosure.

FIG. 4 is a flow chart illustrating contextual response generation and knowledge accumulation in accordance with an embodiment of the present disclosure.

FIG. 5 is a block diagram illustrating a dynamic context system that uses a graph database in accordance with an embodiment of the present disclosure.

FIG. 6 is a flow chart illustrating a data retrieval and context window construction in accordance with an embodiment of the present disclosure.

FIG. 7 is a drawing illustrating connections between different types of entities in accordance with an embodiment of the present disclosure.

FIG. 8 is a flow chart illustrating context node crawling in accordance with an embodiment of the present disclosure.

FIG. 9 is a flow chart illustrating adaptive context windows in accordance with an embodiment of the present disclosure.

FIG. 10 is a drawing illustrating a push-pull graph system workflow in accordance with an embodiment of the present disclosure.

FIG. 11 is a block diagram illustrating a system architecture in accordance with an embodiment of the present disclosure.

FIG. 12 is a flow chart illustrating a workflow for adaptive use cases in accordance with an embodiment of the present disclosure.

FIG. 13 is a drawing illustrating retrieving, evaluating, and refining of contextual knowledge in accordance with an embodiment of the present disclosure.

FIG. 14 is a drawing illustrating swarm-based summation in accordance with an embodiment of the present disclosure.

FIG. 15 is a drawing illustrating the building of relevant and summarized context in accordance with an embodiment of the present disclosure.

FIG. 16 is a block diagram illustrating an example of a computer in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system that determines a dynamic content window is described. This computer may include: an interface circuit that communicates with an electronic device (which may be external or internal to the computer system); a computation device (such as a processor, a graphics processing unit or GPU, etc.) that executes program instructions; and memory that stores the program instructions. During operation, the computer system receives, from the electronic device, an input vector. Then, the computer system accesses, in a graph database (such as a vector graph database), information specifying a context associated with the input vector. Moreover, the computer system determines a dynamic content window based at least in part on the context, where the dynamic content window specifies a subset of content in the input vector, and the dynamic content window has a length less than a predefined value. Next, the computer system provides, to a pretrained neural network, the input vector and the dynamic content window. Furthermore, the computer system receives, from the pretrained neural network, a response vector, and provides, addressed to the electronic device, the response vector.

By determining the dynamic content window, these analysis techniques may significantly reduce the amount of memory, processing capability and communication resources needed during operation of the pretrained neural network. Moreover, the analysis techniques may significantly reduce the power consumption and analysis time used during operation of the pretrained network work. Consequently, the analysis techniques may significantly improve the performance of the pretrained neural network and may significantly reduce the cost of operating the pretrained neural network. These advances may address technological limitations of many pretrained neural networks (such as LLMs), which may allow the advantages offered by these pretrained neural networks to be leveraged without requiring the architectural or training of the pretrained neural networks to be changed. Therefore, the analysis techniques may improve the user experience when operating and/or using the pretrained neural networks.

In the discussion that follows, the analysis techniques are used to analyze a wide variety of types of data or inputs, including or corresponding to: images (such as ultrasound images corresponding to wavelengths between 0.2 and 1.9 mm, Infra-red images corresponding to one or more wavelengths between 700 nm and 1 mm, optical images corresponding to one or more visible wavelengths between 300 and 800 nm, ultraviolet images corresponding to ultraviolet wavelengths between 10 and 400 nm, or X-ray images corresponding to one or more wavelengths between 0.01 and 10 nm), software code, medical data (such as data associated with an electronic medical record), financial data, economic data, data associated with a database or data structure, and/or natural language (such as a portion of a narrative, or a portion of a conversation, e.g., between an individual and a pretrained neural network).

In some embodiments, the analysis techniques may use one or more neural networks or analysis models that are pretrained or predetermined using a machine-learning technique (such as a supervised learning technique, an unsupervised learning technique and/or a neural network) and a training dataset. For example, the analysis model may include a classifier or a regression model that was trained using: a support vector machine technique, a classification and regression tree (CART) technique, logistic regression, LASSO, linear regression, nonlinear regression, a K nearest-neighbors technique (where K is a non-zero integer), a generative model, a Fisher discriminator, a kernel method, a decision tree, a random forest, a boosting technique, a linear perceptron, a neural network technique (such as a CNN, an LLM, an autoencoder neural network, a feedforward neural network, a generative adversarial neural network, a multilayer perceptron neural network, a long short-term memory neural network, a radial basis function neural network, or another type of neural network) and/or another linear or nonlinear supervised-learning technique.

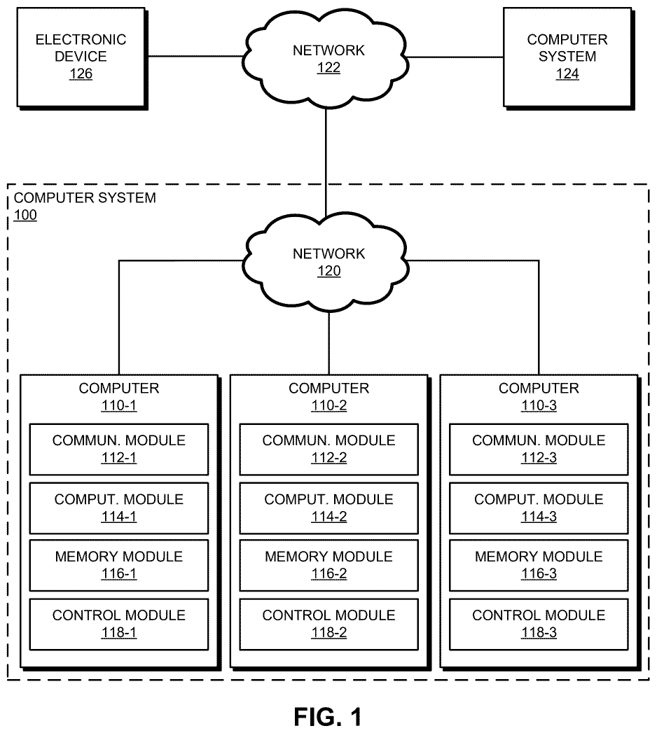

We now describe embodiments of the analysis techniques. Notably, in the discussion that follows, the analysis techniques are used to determine a dynamic content window for a pretrained neural network (such as an LLM) based at least in part on a context (which may be predetermined and stored in a graph database) associated with an input vector to the pretrained neural network. FIG. 1 presents a block diagram illustrating an example of a computer system 100. This computer system may include one or more computers 110. These computers may include: communication modules 112, computation modules 114, memory modules 116, and optional control modules 118. Note that a given module or engine may be implemented in hardware and/or in software.

Communication modules 112 may communicate frames or packets with data or information (such as input vectors or control instructions) between computers 110 via a network 120 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 112 may communicate the data or the information using a wireless communication protocol, such as: an IEEE 802.11 standard (which is sometimes referred to as ‘Wi-Fi’, from the Wi-Fi Alliance of Austin, Texas), Bluetooth (from the Bluetooth Special Interest Group of Kirkland, Washington), a third generation or 3G communication protocol, a fourth generation or 4G communication protocol, e.g., Long Term Evolution or LTE (from the 3rd Generation Partnership Project of Sophia Antipolis, Valbonne, France), LTE Advanced (LTE-A), a fifth generation or 5G communication protocol, other present or future developed advanced cellular communication protocol, Citizens Broadband Radio Service (CBRS), and/or another type of wireless interface or wireless communication protocol. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 110 (such as computer 110-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 1 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 1 may use one or more bands of frequencies, such as: 900 MHz, 2.4 GHz, 5 GHz, 6 GHz, 60 GHz, the CBRS (e.g., a frequency band near 3.5 GHz), and/or a band of frequencies used by LTE or another cellular-telephone communication protocol or a data communication protocol. In some embodiments, the communication between the components may use multi-user transmission (such as orthogonal frequency division multiple access or OFDMA).

Moreover, computation modules 114 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 116 may access stored data or information in memory that local in computer system 100 and/or that is remotely located from computer system 100. Notably, in some embodiments, one or more of memory modules 116 may access stored information (such a context associated with an input vector) in a graph database (e.g., a vector graph database) or data structure. Alternatively or additionally, in other embodiments, one or more memory modules 116 may access, via one or more of communication modules 112, stored information in the remote memory in computer system 124, e.g., via network 120 and network 122. Note that network 122 may include: the Internet and/or an intranet. However, in other embodiments, the context may be determined in real-time or on-the-fly and, thus, may not be predetermined and stored in memory.

While FIG. 1 illustrates computer system 100 at a particular location, in other embodiments at least a portion of computer system 100 is implemented at more than one location. Thus, in some embodiments, computer system 100 is implemented in a centralized manner, while in other embodiments at least a portion of computer system 100 is implemented in a distributed manner. This remote processing may reduce the amount of data that is communicated via network 120 and network 122.

Although we describe the computation environment shown in FIG. 1 as an example, in alternative embodiments, different numbers or types of components may be present in computer system 100. For example, some embodiments may include more or fewer components, a different component, and/or components may be combined into a single component, and/or a single component may be divided into two or more components.

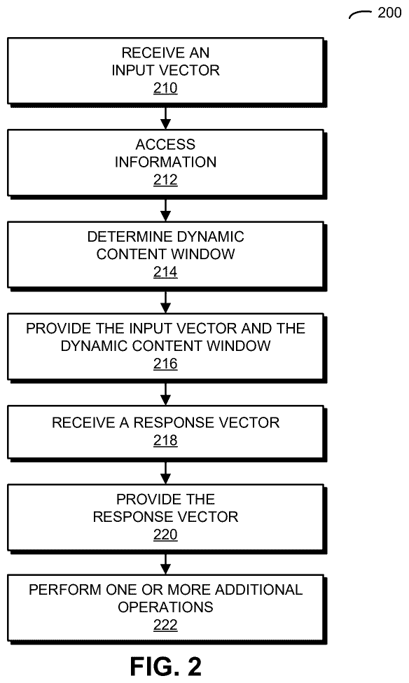

As discussed previously, existing pretrained neural networks often use a fixed (and large) content window. This can degrade the performance of the pretrained neural networks. Moreover, as described further below with reference to FIGS. 2-15, in order to address these challenges computer system 100 may perform the analysis techniques. Notably, during the analysis techniques, one or more of optional control modules 118 may divide the analysis among computers 110. Then, a given computer (such as computer 110-1) may perform at least a designated portion of the analysis. For example, computation module 114-1 may access information (e.g., using memory module 116-1) specifying context.

During operation, communication module 112-1 receive, from electronic device 126, an input vector. Then, computation module 114-1 may access, in a graph database (such as a vector graph database) in or associated with memory module 116-1, information specifying a context associated with the input vector. Moreover, computation module 114-1 may determine a dynamic content window based at least in part on the context, where the dynamic content window specifies a subset of content in the input vector, and the dynamic content window has a length less than a predefined value.

Next, computation module 114-1 may provide, to a pretrained neural network (such as an LLM), the input vector and the dynamic content window. Note that the pretrained neural network may be implemented by computer system 100. Alternatively, the pretrained neural network may be implemented remotely, e.g., by another computer system (not shown). In these embodiments, computation module 114-1 may provide the input vector and the dynamic content window to the (remote) pretrained neural network using communication module 112-1.

Furthermore, computation module 114-1 may receive, from the pretrained neural network, a response vector. Additionally, computation module 114-1 may instruct communication module 112-1 to provide one or more packets or frames, addressed to electronic device 126, the response vector. In some embodiments, computation module 114-1 may update, using memory module 116-1 and in the graph database, the context based at least in part on the input vector and the response vector.

In these ways, computer system 100 may reduce the amount of system resources used during operation of the pretrained neural network. For example, by determining the dynamical content window, computer system 100 may reduce the amount of memory, processing capability and communication resources needed during operation of the pretrained neural network, and thus may significantly reduce the power consumption and analysis time used during operation of the pretrained network work. For example, after 50 back-and-forth interactions in a conversation, the context window may have used 32,400 tokens (versus 1.7 M tokens with the existing context window techniques) or a power reduction of 98.1%. Moreover, the cost may be $0.32 (versus $1735 with the existing context window techniques) or a cost reduction of 98.2%. These advances may address technological limitations of many pretrained neural networks (such as LLMs), which may allow the advantages offered by these pretrained neural networks to be leveraged without requiring the architectural or training of the pretrained neural networks to be changed. Consequently, computer system 100 may improve the user experience when operating and/or using the pretrained neural networks.

We now describe embodiments of the method. FIG. 2 presents a flow diagram illustrating an example of a method 200 for determining a dynamic content window, which may be performed by a computer system (such as computer system 100 in FIG. 1). During operation, the computer system may receive, from an electronic device, an input vector (operation 210). Then, the computer system may access, in a graph database, information (operation 212) specifying a context associated with the input vector. Moreover, the computer system may determine the dynamic content window (operation 214) based at least in part on the context, where the dynamic content window specifies a subset of content in the input vector, and the dynamic content window has a length less than a predefined value. Next, the computer system may provide, to a pretrained neural network, the input vector and the dynamic content window (operation 216). Furthermore, the computer system may receive, from the pretrained neural network, a response vector (operation 218) or output, and may provide, addressed to the electronic device, the response vector (operation 220).

Note that the graph database (or data structure) may include a vector graph database.

Moreover, the pretrained neural network may include an LLM.

Furthermore, the input vector may correspond to: software code, a portion of a narrative, or a portion of a conversation between an individual and the pretrained neural network.

In some embodiments, the predefined value may be less than or equal to 8,095 tokens (or, equivalently, 6,000 words). Alternatively or additionally, the predefined value may be significantly smaller than 128,000 tokens.

Moreover, the dynamic content window may correspond to a next operation or operation in an interaction between the electronic device and the pretrained neural network.

Furthermore, the pretrained neural network may be implemented using a second computer system, where the second computer system is different from the computer system.

Additionally, the response vector may be based at least in part on the input vector and the dynamic content window.

In some embodiments, the pretrained neural network may include one or more convolutional layers, one or more residual layers and one or more dense layers. Note that a given node in a given layer in the pretrained neural network may include an activation function that includes: a ReLU, a leaky ReLU, an ELU activation function, a parametric ReLU, a tanh activation function, and/or a sigmoid activation function.

In some embodiments, the computer system may optionally perform one or more additional operations (operation 222). For example, during operation, the computer system may update, in the graph database, the context based at least in part on the input vector and the response vector.

In some embodiments of method 200, there may be additional or fewer operations. Furthermore, the order of the operations may be changed, and/or two or more operations may be combined into a single operation.

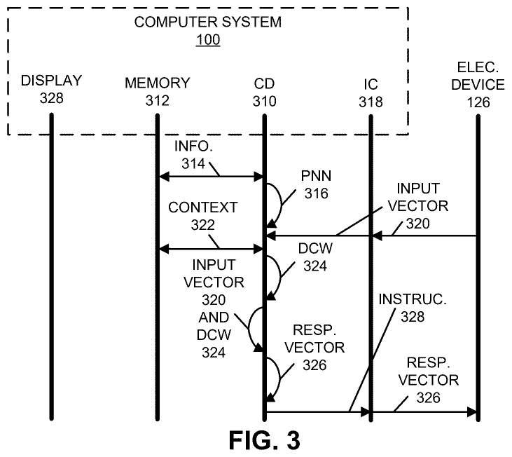

Embodiments of the analysis techniques are further illustrated in FIG. 3, which presents a drawing illustrating an example of communication among components in computer system 100. In FIG. 3, a computation device (CD) 310 (such as a processor or a GPU) in computer system 100 may access, in memory 312 in computer system 100, information 314 specifying configuration instructions and hyperparameters for a pretrained neural network (PNN) 316. After receiving the configuration instructions and the hyperparameters, computation device 310 may implement the pretrained neural network 316.

Moreover, an interface circuit (IC) 318 in computer system 100 may receive, from electronic device 126, an input vector 320, which may be provided to computation device 310. Then, computation device 310 may access, in a graph database in memory 312, information specifying a context 322 associated with input vector 320.

Furthermore, computation device 310 may determine the dynamic content window (DCW) 324 based at least in part on context 322, where the dynamic content window 324 specifies a subset of content in input vector 320, and the dynamic content window has a length less than a predefined value.

Next, computation device 310 may provide, to pretrained neural network 316, input vector 320 and the dynamic content window 324. Furthermore, computation device 310 may receive, from pretrained neural network 316, a response vector 326.

Additionally, computation device 310 may provide an instruction 328 to interface circuit 318 to provide, addressed to electronic device 126, response vector 326.

While FIG. 3 illustrates communication between components using unidirectional or bidirectional communication with lines having single arrows or double arrows, in general the communication in a given operation in this figure may involve unidirectional or bidirectional communication. Moreover, while FIG. 3 illustrates operations being performed sequentially or at different times, in other embodiments at least some of these operations may, at least in part, be performed concurrently or in parallel.

We now further describe embodiments of the analysis techniques. The disclosed analysis techniques provide a dynamic artificial intelligence (AI) context system that may seamlessly integrate one or more adaptive graph databases with language model agents operating in a distributed framework. This design may enable real-time, scalable, and self-updating interactions for a wide range of AI-driven applications. Unlike traditional monolithic approaches, which are often rigid and resource-intensive, this approach may employ asynchronous data retrieval and distributed processing to achieve unparalleled scalability, efficiency, and fault tolerance.

In some embodiments, the disclosed analysis techniques may include real-time knowledge evolution. With every interaction, the computer system may retrieve and process relevant information from an adaptive graph database, while also storing new knowledge (or updates) automatically. This capability may ensure that the computer system continuously evolves, thereby maintaining long-term context and consistency without overwhelming the processing capacity of the pretrained neural network. The selective filtering and context window optimization in the analysis techniques may allow the computer system to handle large-scale, complicated datasets while retaining access to full historical knowledge.

In order to address the limitations of traditional AI systems (such as difficulties in maintaining coherent long-term context, managing vast datasets, and dynamically integrating new information), the analysis techniques may incorporate one or more of: distributed context processing (such as asynchronous ingestion and processing of vast datasets to reduce the computational load on individual systems, thereby enabling faster and more efficient operations); self-updating knowledge store (in which newly generated or learned information may be automatically structured and integrated into a graph database, thereby ensuring consistent and reliable knowledge retention); a scalable graph-database architecture (e.g., a dynamic, graph-based framework that efficiently stores, updates, and queries interconnected data at scale); contextual node crawling (which may provide efficient traversal of graph nodes and edges using relevance scoring and dynamic depth control to retrieve only necessary information); adaptive context windows (in which the use of real-time adjustment of context windows may ensure that only the most relevant information is passed to the pretrained neural network, thereby helping to maintain coherence over extended interactions); and/or relevance filtering and vectorization (in which graph traversal may be combined with vector embeddings to enhance precision and streamline downstream AI model processing).

The disclosed analysis techniques may be used with applications that require persistent memory, scalable performance, and real-time adaptability. It may support use cases such as: adaptive knowledge systems, personalized learning environments, real-time storytelling, and/or enterprise-level AI workflows. In the process, the analysis techniques may provide a blend of flexibility, efficiency, and contextual accuracy. This approach may revolutionize generative AI by delivering smarter, context-aware interactions that are highly scalable, cost-effective, and capable of long-term knowledge retention.

Moreover, the disclosed analysis techniques may address shortcomings in generative AI systems and/or may unlock opportunities in a variety of industries that require long-term coherence, real-time adaptability, and resource efficiency. Notably, the analysis techniques may facilitate the retention of long-term context across interactions. Existing systems often struggle to maintain coherence over extended interactions. They are often limited by static memory models or session-based context windows, which usually lose track of prior inputs once the session ends. This may restrict the ability of AI (or neural networks) to function effectively in tasks requiring continuity, such as personalized learning, long-term medical care, or legal research. In the disclosed analysis techniques, persistent, real-time memory may be introduced by leveraging a graph database that stores and retrieves contextual knowledge dynamically. This may enable: AI-powered systems (e.g., tutors, therapists, customer service agents, etc.) to remember prior user interactions across days, weeks, or years, thereby providing a seamless and coherent experience; and/or advanced continuity in fields like research assistance or legal case preparation.

Furthermore, the analysis techniques may provide scalability and resource efficiency. Existing AI solutions are often tied to large, resource-intensive models with massive context windows, which can be computationally expensive and environmentally taxing. Conversely, smaller models with lower memory capabilities often lack the sophistication to perform well without overwhelming context sizes. In the disclosed analysis techniques, models of all sizes (small, medium, and/or large) may operate efficiently by including one or more of: adaptive context windows that retrieve only the most relevant data, and which may be tailored to the processing capacity associated with a pretrained neural network or model; and/or the ability to maintain high performance without needing computationally expensive monolithic systems (this may democratize AI capabilities, thereby making advanced systems accessible to smaller organizations with limited resources).

Additionally, the analysis techniques may provide a greener approach to AI through optimized resource usage, which may contribute to sustainability goals by reducing computation and energy requirements.

In some embodiments, the analysis techniques may facilitate real-time learning and knowledge integration. Traditional generative AI systems typically do not have mechanisms to learn or adapt dynamically during interactions. Most of these existing approaches require retraining, manual updates, or explicit developer intervention to incorporate new knowledge. This can create delays in responsiveness to emerging information, limit the flexibility of applications, and/or increase operational costs. IN the disclosed analysis techniques, the self-updating knowledge store may allow the AI to: assimilate new information rapidly and to add it to the knowledge graph; adapt its understanding and responses in real time, which may be useful for applications such as: crisis management, financial market analysis, and/or evolving customer support systems; and/or deliver insights that are current and relevant, thereby reducing downtime and ensuring the computer system is as dynamic as the environments it operates in.

Note that the analysis techniques may provide insights ranging from obvious to deep contexts. Traditional systems often struggle to handle complicated queries or to derive insights from interrelated data. Current approaches often focus only on surface-level context, which may leave nuanced or hidden patterns unexamined. By leveraging contextual node crawling and/or graph-based intelligence, the disclosed analysis techniques may dynamically retrieve surface-level and/or deep contextual information. These capabilities may: enable discovery of hidden relationships or patterns, such as subtle trends in customer behavior or correlations between unrelated variables in financial datasets; and/or enhanced decision-making capabilities in fields such as medicine, where deep contextual awareness could may reveal links between symptoms, environmental factors, and/or treatment outcomes.

Moreover, the analysis techniques may provide real-time adaptability and flexibility. Existing AI systems often perform poorly when the scope of interaction changes rapidly or when unexpected contexts are introduced. Typically, static adaptability models cannot adjust in real time without reprogramming or retraining. In contrast, the analysis techniques may provide real-time adaptability through: dynamic updates to the adaptive graph database to respond to emerging needs and evolving conditions seamlessly; and/or versatility in handling dynamic, multi-turn conversations where the context changes unpredictably, such as in disaster response systems or interactive storytelling.

Furthermore, the analysis techniques may provide enhanced resource cost management. Existing AI systems usually rely on large-scale models for sophisticated tasks, which may result in inflated operational costs and may make them inaccessible to smaller enterprises or non-profits. The disclosed analysis techniques may redefine the cost-performance balance by enabling: smaller, resource-efficient models (such as a pretrained neural network) to deliver high-quality results with contextual precision; flexible use of distributed agents, which may allow tasks to be split across smaller compute systems, and which may reduce the need for large-scale, centralized resources; cost-effectiveness in deploying scalable AI solutions for businesses of all sizes, thereby enabling broader adoption of advanced AI technologies.

Thus, the analysis techniques may address foundational inefficiencies in existing AI systems while opening doors to revolutionary applications. By introducing mechanisms for long-term memory, real-time learning, and/or contextual depth, the analysis techniques may help address the problems of scalability, coherence, adaptability, and/or resource cost. Applications of the analysis techniques may span diverse industries, creating opportunities for innovation in fields ranging from adaptive learning and personalized healthcare to smart cities and dynamic marketing systems.

The analysis techniques may manage user interactions intelligently, thereby providing precise and contextually relevant responses while maintaining coherence over extended conversations. A computer system that implements the analysis techniques may provide an advanced, adaptive engine for processing and managing AI interactions. Its primary functions may include: dynamic context management, e.g., via a visible context window (in which the interaction may be presented to the user, and which may include information explicitly relevant to the query from a user); and a hidden context window (with a filtered subset of data retrieved from the knowledge database, which may be used internally by the pretrained neural network to generate accurate, context-driven responses); query refinement and precision (which may enhance user queries by identifying implicit and explicit entities, e.g., names, places, or objects, and may formulates precise database queries to extract relevant data); real-time knowledge integration (which may extract, structure, and/or incorporate information gained during interactions into the knowledge graph for future reference or use); relevance filtering (which may filter out irrelevant or excessive information to streamline processing and help ensure concise, accurate responses); response generation (which may produce coherent and contextually accurate answers based at least in part on the combined data from the hidden context window and user queries or input vectors); and/or information ingestion and database generation (which may identifies entity types, properties, relationship structures, and entities from dynamic input types to generate or modify reference graph-database components).

We now describe workflows in the analysis techniques. Notably, in some embodiments, the analysis techniques may include several stages, which combine graph-database management, language-model (or LLM) processing, and contextual filtering to provide efficiency and relevance. A first stage may include use input and query submission. In the first stage, a user interacts with the computer system, submitting a query through the user-facing model. For example, a user may ask: ‘What types of donuts are available at Joe's Bakery?’ The visible context window may initially contain only the input (or input vector) from the user. In response, the computer system may parse the user query to identify entities (e.g., ‘Joe's Bakery’ and ‘donuts;) and their relationships. Implicit entities or additional clarifications may also be extracted (e.g., recognizing ‘available’ implies inventory or a menu).

A second stage may include entity expansion and query transformation. Notably, the computer system may refine the query of the user by adding contextual details based on the entities identified. For example, an original query may be: ‘What types of donuts are available at Joe's Bakery?’ The transformed query may be: ‘Retrieve a list of donuts currently available at Joe's Bakery.’ This stage may involve the language model or summarization component expanding the query by referencing known relationships in a graph database. A cypher query or equivalent database query may be generated. This query may specifically target the relevant node(s) and edges in a knowledge graph.

Moreover, a third stage may include database query and information retrieval. Notably, the query may be executed on an adaptive graph database to retrieve information about the relevant entities (e.g., ‘Joe's Bakery’ and ‘donuts’). Only information relevant to the query (e.g., a list of available donuts) may be pulled into the hidden context window. This stage may involve contextual node crawling. For example, the computer system may traverse the graph database, starting with the bakery node. It may follow edges labeled as ‘sells’ or ‘has inventory’ to retrieve related nodes representing donut types. In addition, relevance filtering in which irrelevant information (such as calorie counts, a bakery address, or historical sales data) may be excluded unless explicitly relevant to the query.

A fourth stage may include summarization and context construction. Notably, the retrieved data may be summarized into concise, readable information for the hidden context window. For example, raw data, such as ‘Joe's Bakery has inventory nodes for chocolate donuts, glazed donuts, and jelly donuts, each with additional metadata like calories, supplier info, etc.’ Moreover, a hidden context may be summarized, such as ‘Joe's Bakery offers chocolate, glazed, and jelly donuts.’ The summarization model (such as program instructions or a pretrained neural network) may process the raw data to: remove redundant or extraneous details; and/or Format the relevant information concisely for the language model (or another pretrained neural network).

Furthermore, a fifth stage may include response generation. Notably, the language model or LLM may combine the user query (visible context) with the hidden context to generate an appropriate response. For example, the response to user may be: ‘Joe's Bakery offers chocolate, glazed, and jelly donuts.’ In order to do this, the language model may use the hidden context as a factual basis to craft a response tailored to the original query. When the user follows up with additional questions (e.g., ‘What are the most popular?’), the computer system may dynamically update the context windows and retrieve additional data as necessary.

A sixth stage may include knowledge integration. Notably, any new or update information provided during the interaction (e.g., ‘Joe's Bakery is known for its jelly donuts’) may be identified, structured, and added to the graph database for future use. For example, a new node may be added: ‘Joe's Bakery’->‘is known for’->‘jelly donuts.’ In order to do this, the computer system may summarize the new information and represents it as a new node or edge in the graph database. Moreover, consistency checks may ensure the data does not conflict with existing information.

The analysis techniques may offer clear advantages over both current state-of-the-art systems and potential hypothetical alternatives. Notably, the analysis techniques may provide long-term context retention. Current AI systems often rely on static memory models or large context windows, which ‘forget’ information or loose coherence after a session, require inefficient appending of prior interactions, and/or are usually resource intensive. This can lead to a loss of coherence in long-term conversations. Moreover, hypothetical alternatives may attempt to solve this by extending context windows further or storing embeddings, but this would result in significant computational overhead and degraded performance over time. In contrast, the disclosed analysis techniques may solve the problem with a graph-based long-term memory, allowing it to persist and recall context dynamically, without bloating the context window. This may maintain coherence across extended interactions, independent of their duration.

Moreover, the analysis techniques may provide scalability across model or pretrained neural network sizes. Current systems often rely on monolithic architectures and massive models to achieve high performance, making them inaccessible to smaller organizations due to high computational costs. Hypothetical alternatives may address this by building specialized smaller models for specific tasks, but these are often constrained by limited functionality and lack the ability to scale efficiently. In contrast, the disclosed analysis techniques may enable small, medium, and large models to achieve comparable performance by optimizing context windows and leveraging distributed agent systems, making it both cost-effective and scalable.

Furthermore, the analysis techniques may provide real-time knowledge updates. Existing solutions typically require manual interventions or periodic retraining to incorporate new knowledge into their operational memory, leading to delays and inefficiencies. A hypothetical alternative may use a combination of embedding updates and periodic re-indexing, but this would likely lack the flexibility and precision needed for real-time interactions. In contrast, the disclosed analysis techniques may integrate real-time updates through a push mechanism, rapidly or instantly updating its graph database with new information. This may ensure rapid or immediate adaptability without the need for downtime or retraining.

Additionally, the analysis techniques may provide relevance filtering and precision. Current AI systems usually retrieve broad sets of information, often resulting in irrelevant or extraneous details being included in responses. Users often must sift through unnecessary data manually. Alternatives may employ more-complicated embeddings or vector-based retrieval mechanisms, but these often fail to prioritize specific task relevance and can overload models with excessive data. In contrast, the disclosed analysis techniques may employ contextual node crawling and relevance filtering, retrieving only the most pertinent data from its graph database. This may avoid overloading the language model with unnecessary information, ensuring concise and focused responses.

In some embodiments, the analysis techniques may provide plug-and-play simplicity. Current systems typically require significant expertise in graph databases, language model integration, and distributed architectures to deploy and operate effectively. This can create a steep learning curve for implementation. A potential alternative may abstract some complexity for the user, but could still require manual setup of infrastructure or domain-specific integration. In contrast, the disclosed analysis techniques may be designed to function as a plug-in for language model agents, abstracting its own complexity. Users may not need to understand the inner workings of graph databases, distributed systems, or integration mechanics. This may allow the computer system to operate autonomously, providing advanced functionality with minimal setup or expertise.

Note that the analysis techniques may provide reduced resource costs. Systems like GPT-based architectures often demand enormous computational resources to maintain large context windows or to train and deploy largescale models, making them inaccessible to smaller organizations. Hypothetical systems may address this by reducing model size or context window size, but these approaches sacrifice precision and functionality in the process. In contrast, the disclosed analysis techniques may optimize resource usage by dynamically adjusting context windows, enabling smaller models to deliver high-quality outputs. This may eliminate the need for resource-intensive monolithic architectures while retaining precision and relevance.

Moreover, the analysis techniques may provide deep contextual insights. Current systems often use embeddings to find relationships, but often fail to detect subtle dependencies or connections between entities, especially in complicated, interrelated data. Hypothetical alternatives may attempt to expand embedding-based similarity scoring, but would likely struggle to integrate relational and semantic insights effectively. In contrast, the disclosed analysis techniques may leverage a graph-based architecture to derive both explicit and implicit relationships between entities. This may provide nuanced insights that go beyond simple embedding-based retrieval.

Furthermore, the analysis techniques may provide real-time adaptability. Traditional systems typically require significant time to adapt to new queries or updated knowledge, often failing to respond dynamically in fast-changing environments. Potential alternatives may address adaptability by increasing retraining frequency or adding external rule-based mechanisms, but these approaches would lack flexibility and scalability. In contrast, the disclosed analysis techniques may dynamically adjust to new interactions, queries, and data updates in real time, thereby helping to ensure its responses remain contextually relevant.

The disclosed analysis techniques use initial schema definitions and dynamically populate a graph database. Moreover, the computer system may dynamically define its schema, make assumptions and groom data autonomously, thereby significantly reducing setup time. In some embodiments, the computer system may process documents, data structures, databases and other ingestible sources of information to generate the graph database. Furthermore, the distributed agents, adaptive context windows and dynamic graph database in the analysis techniques may provide flexibility and scalability across different domains. The resulting complexity may be abstracted for the end user, who may interact with the computer system (e.g., via a plug-in) without needing to understand its internal components. Note that the distributed nature of the computer system may spread workloads across smaller compute units, thereby minimizing bottlenecks and optimizing efficiency.

The analysis techniques may provide a foundational innovation that redefines the use of AI and LLMs (and, more generally, pretrained neural networks) across a vast range of applications and industries. Its unique ability to adapt, evolve, and operate autonomously while maintaining coherence and scalability may make it a transformative tool for an arbitrary domain requiring intelligent, context-aware systems. Moreover, the analysis techniques may facilitate knowledge management and intelligent retrieval.

The computer system may serve as an advanced knowledge engine capable of organizing, retrieving, and maintaining vast, complicated datasets with unparalleled efficiency. By integrating an adaptive graph database and context management, it may provide real-time retrieval of relevant information and the dynamic integration of new knowledge. Applications of the analysis techniques may include: enterprise knowledge systems (e.g., centralizing and contextualizing organizational policies, procedures, and documentation for streamlined workflows); legal and regulatory research (e.g., supporting legal professionals by retrieving relevant case law, statutes, and contextual precedence, while maintaining a record of prior research paths); and/or healthcare data systems (e.g., assisting healthcare providers by organizing and retrieving patient data, treatment plans, and/or research, while preserving long-term coherence across sessions).

Moreover, the analysis techniques may provide adaptive learning and personalized education. Notably, the analysis techniques may provide a robust framework for adaptive learning systems by dynamically tailoring content to individual users, tracking their progress, and/or offering contextual insights. This capability may enable: personalized learning platforms (e.g., customizing educational materials and pacing based at least in part on a learner's strengths, weaknesses, and/or progress); dynamic tutoring (e.g., by acting as an intelligent tutor capable of adapting to a student's specific needs, answering questions with accuracy, and/or maintaining long-term learning paths); and/or content expansion (e.g., by seamlessly integrating new materials, courses, or topics without requiring manual updates or interventions).

Furthermore, the analysis techniques may provide intelligent programming and code assistance. Notably, as a programming assistant, the computer system may enable developers to work more efficiently by providing targeted, relevant documentation and/or guidance. This may include: code documentation retrieval (e.g., fetching and summarizing functions and/or libraries); error debugging and resolution (e.g., by diagnosing and resolving errors by referencing relevant code snippets, patterns, or troubleshooting operations); and/or code integration guidance (e.g., offering context-aware suggestions for integrating multiple libraries, optimizing workflows, and/or creating efficient solutions).

Additionally, the analysis techniques may provide customer service and support automation. Notably, the analysis techniques may be used to provide: a dynamic back-end for customer service platforms, thereby enabling contextually relevant, personalized, and/or efficient interactions; multi-turn conversations (e.g., by retaining and using an interaction history to provide consistent and personalized support across multiple sessions); FAQ automation (e.g., by dynamically retrieving and summarizing policy, product, or service information based at least in part on user queries or input vectors); and/or issue resolution (e.g., handling complicated queries by synthesizing data from multiple sources to offer comprehensive solutions).

Note that the analysis techniques may provide real-time decision support systems. Notably, the real-time adaptability and ability to derive insights from interconnected data make the computer system a powerful tool for decision-making in dynamic environments, such as: healthcare (e.g., recommending treatments, diagnosing conditions, or summarizing medical research based at least in part on patient data and evolving knowledge bases); financial analysis (e.g., assisting in investment decisions by analyzing market trends, retrieving contextual financial data, and/or predicting outcomes); and/or disaster management (e.g., responding to crises by synthesizing large volumes of incoming data and/or providing actionable recommendations to decision-makers).

Moreover, the analysis techniques may provide storytelling, gaming, and/or content generation. Notably, the analysis techniques may enable dynamic, adaptive storytelling and gaming by leveraging its long-term memory and contextual understanding. This may include: interactive storytelling (e.g., generating narratives that evolve based at least in part on user choices while maintaining coherence and consistency in character and plot development); gaming engines (e.g., supporting non-player character or NPC interactions, dynamic quest generation, and/or immersive world-building); and/or generative writing tools (e.g., assisting authors or content creators by suggesting coherent plotlines, dialogue, or thematic structures).

Furthermore, the analysis techniques may provide research and development tools. Notably, the analysis techniques may enhance research workflows by dynamically retrieving, summarizing, and/or contextualizing relevant research materials. This may include: scientific research (e.g., by assisting researchers in exploring interconnected studies, synthesizing findings, and/or tracking historical research paths); and/or technology development (e.g., guiding engineers and developers by offering tailored recommendations on design approaches, frameworks, and/or best practices).

In some embodiments, the analysis techniques may provide domain-specific optimization. For example, the computer system may be tailored for specific industries or domains by customizing the graph-database schema, relevance filtering techniques, and LLM or pretrained neural network integration. Examples may include: healthcare optimization (such as redefined schemas for medical conditions, treatments, and/or research, thereby enabling faster and more accurate retrieval); and/or legal applications (e.g., structuring case law, statutes, and/or arguments for easier reference and long-term tracking).

The analysis techniques may provide multi-language and multimodal support. Notably, the analysis techniques may integrate multimodal data sources (such as images, audio, and video), thereby expanding its applications into fields requiring visual or auditory analysis. This may include: visual diagnosis in medicine (e.g., combining patient records with image recognition to enhance diagnostic precision); and/or video-based learning systems (e.g., summarizing video lectures and linking them to supplementary text-based materials).

Note that the analysis techniques may provide scalable deployment models. For example, the computer system may operate in a variety of deployment configurations to meet specific use cases, such as: cloud-based deployments (e.g., for global scalability and access across large organizations); edge or on-premises deployments (e.g., for industries requiring strict data security, such as government or healthcare); and/or hybrid models (e.g., combining local and cloud systems to optimize performance and resource management).

The analysis techniques may be integrated with existing AI systems. Notably, the analysis techniques may act as a plug-in or program module (or a set of instructions) for existing AI tools and frameworks, thereby extending their functionality without requiring a complete overhaul. This may include: customer relationship management or CRM (e.g., enhancing CRMs by adding real-time contextual memory and insights); and/or code development platforms (e.g., integrating with integrated development environments to provide programming guidance and error correction tools). In some embodiments, the analysis techniques may facilitate augmented collaboration. Notably, the computer system may support collaborative workflows by tracking and contextualizing team inputs and discussions; may facilitate shared knowledge spaces (e.g., by maintaining a collective knowledge graph for teams working on shared projects); and/or may provide a live annotation system (e.g., by dynamically annotating documents or discussions to provide real-time context and relevant links).

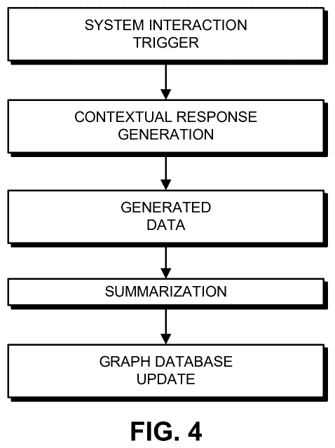

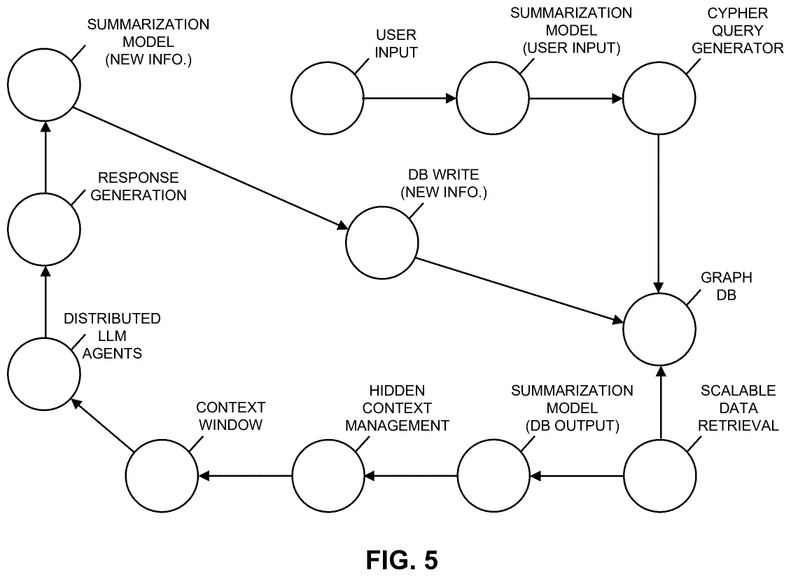

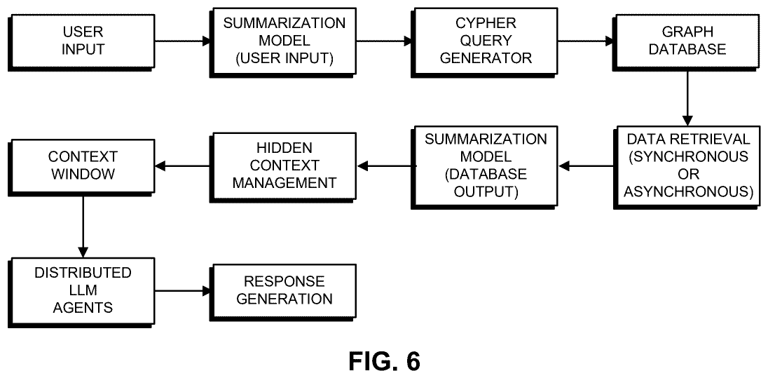

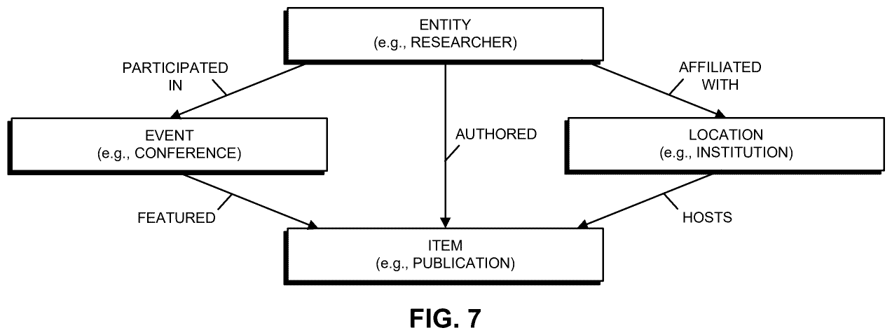

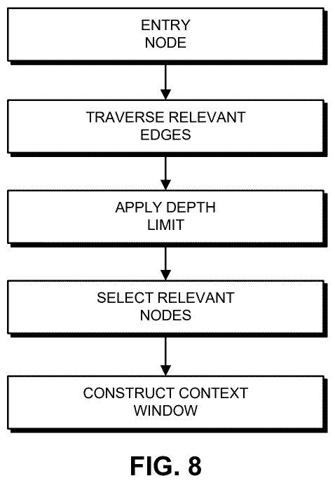

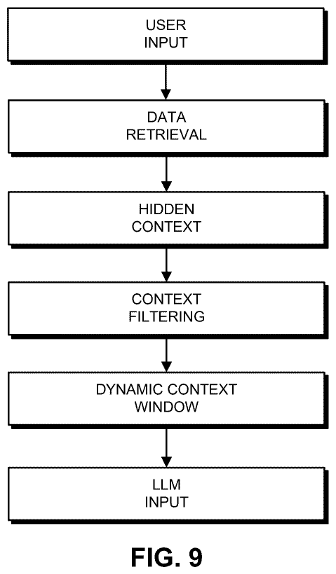

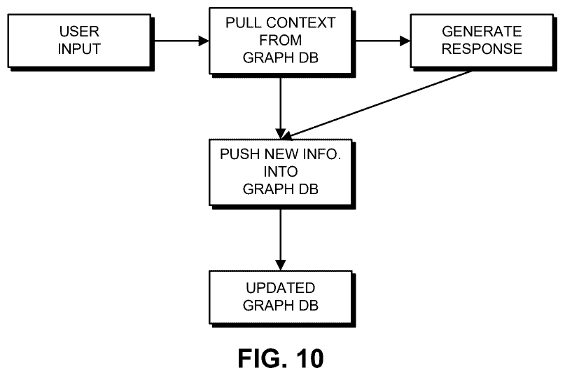

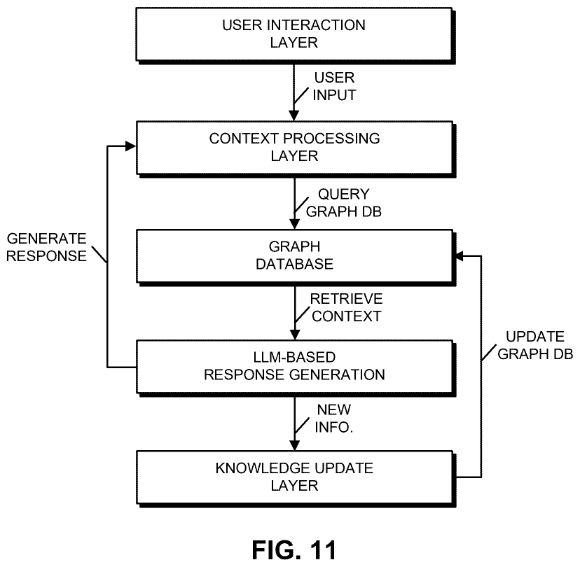

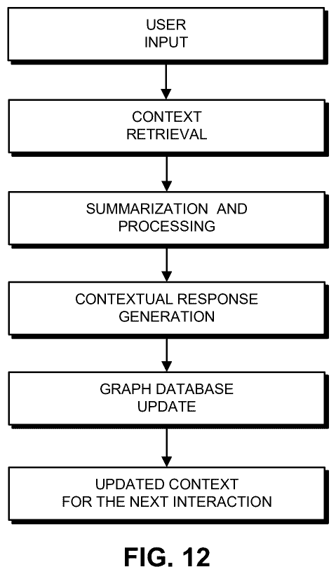

We now provide some drawings illustrating embodiments of the analysis techniques. FIG. 4 presents a flow chart illustrating contextual response generation and knowledge accumulation in accordance with an embodiment of the present disclosure. Moreover, FIG. 5 presents a block diagram illustrating a dynamic context system that uses a graph database (DB) in accordance with an embodiment of the present disclosure. FIG. 6 presents a flow chart illustrating data retrieval and context window construction in accordance with an embodiment of the present disclosure. Furthermore, FIG. 7 presents a drawing illustrating connections between different types of entities in accordance with an embodiment of the present disclosure. FIG. 8 presents a flow chart illustrating context node crawling in accordance with an embodiment of the present disclosure. Additionally, FIG. 9 presents a flow chart illustrating adaptive context windows in accordance with an embodiment of the present disclosure. FIG. 10 presents a drawing illustrating a push-pull graph system workflow in accordance with an embodiment of the present disclosure. Note that FIG. 11 presents a block diagram illustrating a system architecture in accordance with an embodiment of the present disclosure. FIG. 12 presents a flow chart illustrating a workflow for adaptive use cases.

The computer system that implements some or all of the analysis techniques may include one or more interdependent components that function seamlessly to provide context management, data retrieval, and/or real-time adaptability. Below is a detailed description of at least some of these components. In general, there may be fewer or additional components. For example, two components may be combined into a single component, and/or a single component may be divided into two or more components. In general, a given component may be implemented in hardware and/or software.

The adaptive graph database may provide the core knowledge repository, storing entities, relationships, and/or contextual information in a graph structure. It may enable real-time updates, retrieval, and/or dynamic schema definition. The graph database may include: nodes that represent entities (e.g., concepts, objects, events, etc.); edges that represent relationships between nodes, often weighted or annotated with additional metadata (e.g., ‘is related to,’ or ‘has property’); schema adaptability (e.g., the database structure may dynamically evolve based at least in part on the data ingested or new knowledge learned); and/or interaction (which may supply context to the hidden context window during query processing, and/or may update dynamically, e.g., via the push mechanism after interactions).

Moreover, the visible context window may represent the user-facing component of the computer system, and may contain the query and response exchanged between the user and the computer system. The visible context window may be designed for clarity and relevance, and may show only the interaction information needed by the user. During interaction, the visible context window may directly interface with the user. It may serve as the entry point for queries and the end point for delivering responses.

Furthermore, the hidden context window may act as the internal processing layer for the computer system, and may contain filtered data retrieved from the adaptive graph database that is relevant to the user's query. The hidden context window may be dynamically populated with information retrieved via contextual node crawling. It may maintain coherence across interactions without overloading the pretrained neural network. During operation, the hidden context window may supply contextual data to the pretrained neural network during response generation. It may be updated dynamically with each new query and response cycle.

Additionally, the push-and-pull graph system may manage the flow of information between the graph database and the computer system. It may help ensure that new knowledge is consistently integrated and relevant data is efficiently retrieved. The push mechanism may add newly generated or learned information to the graph database, and the pull mechanism may retrieve relevant data from the graph database for use in the hidden context window. This interaction may enable real-time knowledge updates and seamless integration of new information.

Note that the query processing component may refine and expand user queries into structured database queries, thereby ensuring precise data retrieval. The query processing component may provide: entity recognition (e.g., identifying key entities and relationships in the user query); and/or query transformation (e.g., translating the user's input into optimized queries for the graph database). During interaction, the query processing component may bridge the user's input with the graph database, thereby ensuring relevant and accurate information retrieval.

Moreover, the relevance filtering system may evaluate and prioritize (e.g., rank) data retrieved from the graph database to ensure only the most-relevant information is included in the hidden context window. For example, techniques may score nodes and edges based at least in part on proximity to the query and contextual importance. The relevance filtering system may filter out irrelevant or redundant data, and/or may prioritize contextually important nodes and edges based at least in part on the user query (or input vector). During interaction, the relevance filtering system may: work closely with the graph database to refine query results; and/or supply only meaningful data to the pretrained neural network.

Furthermore, the pretrained neural network (such as an LLM) may generate user-facing responses based at least in part on the combined or synthesizing information from the visible context window (such as the user query or input vector) and hidden context window (e.g., retrieved data). The pretrained neural network may: process natural language inputs or queries and generate coherent, contextually accurate outputs or responses; and/or function as the primary communication layer for the user-facing interaction. During interaction, the pretrained neural network may combine visible and/or hidden context to generate coherent, contextually relevant responses. Note that the pretrained neural network may output the response into the visible context window for the user. In general, the pretrained neural network may be an arbitrary front-facing pretrained neural network that is integrated with the computer system.

Additionally, the summarization model may condense raw data retrieved from the graph database into concise, digestible content for the hidden context window. It may extract key points, simplify complicated information while preserving key insights, and/or format data for efficient processing (such as by reducing the amount of data to be processed by downstream components). During interaction, the summation model may process raw outputs from the graph database to ensure that only pertinent information is passed to the hidden context window.

Moreover, the distributed agent system may handle parallel processing of tasks, such as query parsing, data retrieval, and/or summarization. It may divide computational tasks across smaller, specialized agents to optimize efficiency. During interaction, the distributed agent system may collaborate to process user queries, manage the graph database (such as retrieval), and/or generate responses. The agents may: operate asynchronously to manage tasks such as parsing, filtering, and summarization; and support scalability by distributing workloads across multiple agents.

Furthermore, the dynamic knowledge integration component may manage the ability of the computer system to learn and evolve by incorporating new knowledge into the graph database in real time during interactions. It may: analyze user interactions to identify new entities, relationships, or updates; and/or automate schema adjustments, node creation and/or relationship definitions to accommodate evolving data. During interaction, the distributed agent system may help ensure that the graph database remains up-to-date and relevant for future queries (e.g., by comparing and resolving new data against existing knowledge to maintain consistency).

During operation of the computer system, a user may interact with the computer system through the visible context window to submit a query, thereby initiating an interaction. Then, the query may be processed by the query processing component, which may identify key entities and relationships, and transform the query into a structured database request. Moreover, the pull mechanism may retrieve relevant nodes and edges from the adaptive graph database via contextual node crawling. The retrieved data may be filtered and summarized by the relevance filtering system and summarization model. Next, the filtered and summarized data may be stored in the hidden context window, where it supports response generation. Furthermore, the predefined neural network (such as an LLM) may combine the visible and hidden contexts to craft a coherent and accurate response, which may be delivered back to the user in the visible context window. Additionally, new information or insights generated during the interaction may be processed by the dynamic knowledge integration component and pushed into the graph database via the push mechanism, thereby helping to ensure that the system evolves dynamically.

In the disclosed analysis techniques, the dynamic context management may introduce adaptive context windows, separating user-facing visible context from system-facing hidden context. The hidden context may be dynamically constructed based at least in part on the relevance of retrieved data, thereby optimizing memory usage and maintaining coherence. This approach may resolve the LLM context window limitation by offloading non-critical data to the hidden context, thereby allowing for efficient handling of long-term interactions.

Moreover, the adaptive graph database may transform a traditional graph databases into an adaptive system that dynamically defines its schema and evolves in real time. It may incorporate mechanisms for: dynamic knowledge integration (such as adding new nodes, edges, and/or attributes based on user interactions); and/or contextual node crawling (which may efficiently traversing the database to retrieve only the most-relevant data). This approach may eliminate the need for manual schema creation and updates, thereby enabling seamless adaptation to any domain or dataset.

Furthermore, the push-and-pull knowledge management may establish a dual mechanism for managing knowledge: push may automatically integrate new knowledge into the graph database during and after interactions; and pull may dynamically retrieve contextually relevant information for active queries. Unlike static or retraining-based systems, this approach may ensure real-time knowledge evolution without requiring external intervention.

Additionally, relevance filtering and summarization may introduce advanced techniques for relevance filtering, scoring nodes and edges based at least in part on query importance, and/or summarization, condensing retrieved data into usable forms. This operation may help ensure the hidden context window contains only the most-pertinent information, reducing computational overhead and/or improving response quality.

Note that the distributed language model agents may implement a network of smaller, specialized language model agents that collaborate on tasks such as query parsing, data retrieval, and/or response generation. The distributed agent design may improve scalability and fault tolerance, thereby reducing the reliance on monolithic pretrained neural network (such as LLM) architectures.

Moreover, freeform data ingestion may enable the computer system to initialize its graph database by ingesting and processing freeform documents, databases, and/or text sources. It may use a variant of the pretrained neural network to identify entity types, relationships, and/or schema structures autonomously. This capability may allow the computer system to adapt to any domain without requiring preexisting, structured datasets or manual input.

Furthermore, the computer system may be designed to dynamically adjust to user queries, context changes, and/or newly introduced data in real time. This approach may overcome the static nature of traditional AI systems by integrating adaptability directly into the architecture of the computer system, thereby helping to ensure constant relevance.

Additionally, the use of modularity and plug-and-play design may abstract the complexity of the graph database, distributed systems, and/or pretrained neural network integration, thereby allowing the analysis techniques to operate as a plug-in for AI systems. This approach may allow users to implement the analysis techniques without requiring expertise in the underlying components, thereby reducing the barrier to adoption.

In summary, the analysis techniques may integrate and significantly enhance existing technologies to create a cohesive, adaptive system. By addressing the limitations of static memory models, rigid graph databases, and non-dynamic architectures, it may provide a scalable, real-time AI solution capable of transforming interactions across industries.

We now describe context determination in the analysis techniques. The computer system may employ an advanced graph-based AI-driven system for dynamically retrieving and assembling contextual information. By leveraging a graph database (such as a vectorized graph database), the computer system may ensure accurate, real-time context determination for a given user query. The discussion that follows describes embodiments of how the computer system: crawls through graph nodes to extract relevant information; determines the relevancy of selected objects; and/or pulls relevant properties related to the original query.

In order to facilitate graph traversal for contextual retrieval, the computer system may store knowledge as a graph database, where entities (concepts, people, places, events, etc.) are represented as nodes, and relationships between them are defined as edges. Nodes in the graph may be vectorized, adding additional context capabilities that enhance retrieval and comparison.

When a query is received, the computer system may identifies the user's moving node. Notably, the user may have a ‘moving’ node that is dynamically attached to relevant pieces of information. This moving node may allow for adaptive traversal of the knowledge graph, thereby enabling context-sensitive retrieval.

Then, the computer system may expand the search via node crawling and vectorization. Notably, the computer system may dynamically determine the traversal depth based at least in part on query complexity. The traversal depth may expand outward by following linked nodes, thereby ensuring the most-contextually relevant entities are retrieved. Note that the computer system may use vectorization techniques to compare nearby nodes and refine retrieval based at least in part on semantic similarity.

Moreover, using adaptive depth control, the computer system may ensure the search remains efficient by iteratively expanding or constraining node retrieval. When too much information is retrieved, a relevance filtering technique may prune less significant nodes.

Next, the computer system may perform relevance determination of selected objects. Notably, once nodes are retrieved, the computer system may apply relevance filtering and vectorization to rank their significance. Note that graph-based relevance metrics may include: a node centrality score (which may determine how connected a node is within the network); a contextual similarity score (which may measure how often a node appears in queries with similar intent); and/or recency weighting (which may hives preference to nodes with recent interactions or modifications). Moreover, vector-based context matching may use vector embeddings to compare semantic similarity between the query and retrieved nodes. Entities with high cosine similarity to the query context may be retained, while lower-ranked entities may be discarded. Furthermore, crawling may be performed for additional context. For example, even when vectorization is not performed, the computer system may check and traverse linked nodes. This may help ensure comprehensive retrieval of related entities and a deeper understanding of the data.

Furthermore, the computer system may perform property extraction for a query response. Notably, once the most-relevant nodes have been selected, the computer system may extract and synthesize data. This may include: the retrieval of relevant properties; summarization and contextual condensation; and/or integration with a user context. In the retrieval of relevant properties: only the key attributes (e.g., descriptions, timestamps, relationships, etc.) needed to answer the query may be retrieved; and/or AI-driven agents may be used to determine the most-relevant properties, and recursively summarizing them until a final condensed summary is formed. This approach may enable a scalable summarization system, where queries of increasing complexity may trigger a swarm of summarization agents that can refine responses dynamically. Moreover, in the summarization and contextual condensation, information from multiple nodes may be condensed using AI-driven summarization. This may help ensure concise, yet complete responses, thereby avoiding information overload. Note that the computer system may scale infinitely, using as few as one summarization operation or dynamically expanding based at least in part on query complexity. In the integration with a user context, newly retrieved information may be pushed back into the knowledge store, thereby allowing for continuous learning. When required, new nodes and edges may be dynamically added to enhance future query accuracy.

In some embodiments, the computer system may use a push-and-pull graph mechanism. Notably, the computer system may maintain real-time updates to the graph database using a push-and-pull mechanism. The pull mechanism may retrieve data dynamically based at least in part on user queries and/or existing knowledge. Moreover, the push mechanism may store newly generated insights into the graph for future reference, thereby ensuring that the context is continuously enriched.

By integrating graph-based retrieval, AI-driven query adaptation, and/or dynamic context filtering, the computer system may efficiently determine the most-relevant and useful context for an arbitrary given query or input vector. The scalable, self-adaptive knowledge system may allow for high-precision responses while continuously evolving based at least in part on user interactions.

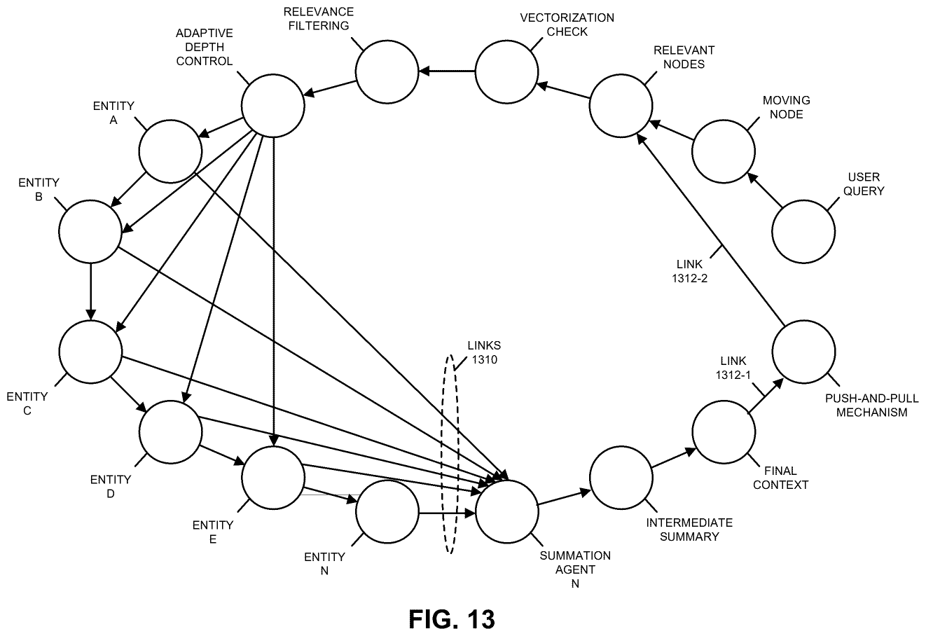

FIG. 13 presents a drawing illustrating retrieving, evaluating, and refining of contextual knowledge at scale in a generalized graph network in accordance with an embodiment of the present disclosure. By leveraging adaptive depth control, scalable AI summarization, and/or a knowledge-enhancing push-and-pull mechanism, the computer system may deliver precise and dynamically evolving context for any given query. Notably, FIG. 13 illustrates how the computer system dynamically retrieves, evaluates, and/or refines contextual information using an adaptive, AI-driven process. The workflow may follow a circular structure, emphasizing how context is generated, filtered, summarized, and/or integrated back into the computer system for continuous updates.

This process may include user query initiation. Notably, a user query may be received, which may trigger the moving node to attach to relevant knowledge graph data.

Then, in relevant node retrieval and processing, the moving node may pull in relevant nodes from the vectorized graph database. A vectorization check may ensure semantic similarity between the query and retrieved nodes. Moreover, relevance filtering may rank the retrieved nodes based at least in part on node centrality, recency weighting, and/or contextual similarity.

Moreover, in adaptive depth control, the computer system may dynamically expand or limit traversal to avoid unnecessary data retrieval. Note that entities A, B, C, D, E, up to variable N may be identified for further processing.

Next, in summarization processing, a summarization agent N may receive relevant entities via links 1310, indicating a scalable summarization process. The summarization agents may recursively process and condense retrieved information. The result may be structured into an intermediate summary before finalizing.

Furthermore, in final context generation, the refined context may be consolidated into the final context. Using the push-and-pull graph mechanism, the final context may be integrated back into the graph database for future queries when new information is found. Notably, a given one of links 1312 from the push-and-pull graph mechanism to the relevant nodes may demonstrate how new knowledge can continuously enhance retrieval and filtering processes.

Note that the summarization agent N may allow for infinite scalability and dynamic adapting to query complexity. Moreover, vectorization and relevance filtering may ensure that only the most-important nodes are selected, thereby optimizing context retrieval and preventing unnecessary data retrieval. Furthermore, adaptive depth control may help ensure efficiency by expanding or limiting retrieval depth. Additionally, the computer system may use recursive summarization for clarity. Data may be processed in multiple summarization stages, thereby ensuring a concise yet comprehensive response. Note that, in continuous knowledge enhancement, the push-and-pull graph mechanism may ensure that newly generated insights refine future queries, thereby making the computer system continuously smarter over time.

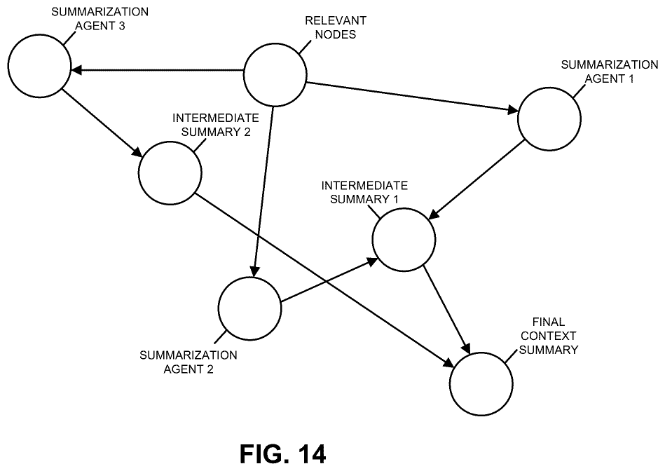

FIG. 14 presents a drawing illustrating swarm-based summation in accordance with an embodiment of the present disclosure. This swarm agent summarization diagram illustrates how the computer system scales summarization dynamically using a swarm of AI agents to refine and condense retrieved information.

This process may include retrieval of relevant nodes the knowledge graph. Summarization agent N may represent a scalable number of AI agents that process and refine information. These agents may work in parallel, breaking down data into intermediate summaries as needed. The computer system may recursively condense the summaries until a final context summary is formed.

Note that this approach may be: scalable (e.g., the number of agents may adjust based at least in part on query complexity); efficient (e.g., data may be summarized in layers, thereby preventing overload); and/or adaptive (e.g., the computer system may continuously optimize responses in real time). FIG. 14 highlights how the computer system may efficiently process complicated queries by leveraging a swarm-based AI summarization approach.

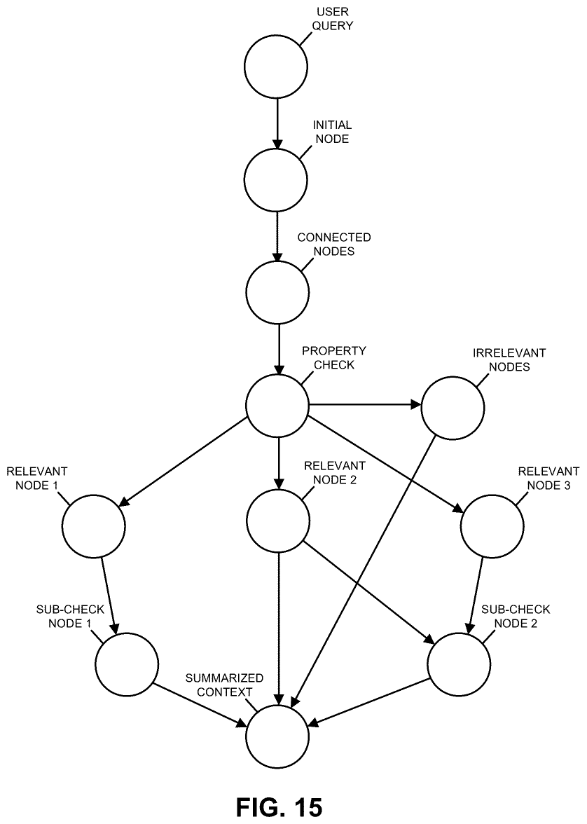

FIG. 15 presents a drawing illustrating the building of relevant and summarized context in accordance with an embodiment of the present disclosure. This organized node crawling Diagram illustrates how the computer system systematically traverses, evaluates, and filters nodes to build a relevant and summarized context from a user's query.

This process may include: a user query initiation (e.g., the computer system may start with the moving the initial node that holds user information); connected nodes discovery (e.g., the computer system may retrieve related nodes sharing direct edges from the knowledge graph); a property check (e.g., each connected node may be evaluated for relevance); relevant nodes continue to be processed (e.g., irrelevant nodes may be discarded from summarized context, but included in a node crawl); recursive crawling (e.g., when a relevant node has additional meaningful connections, those may be further explored in a so-called sub-check nodes operation); and/or summarization and context integration (where relevant properties from the crawled nodes may be synthesized into a final summarized context).

In FIG. 15, the computer system may perform hierarchical node crawling in which the search expands outward, while prioritizing only relevant information. Moreover, the computer system may perform recursive relevance filtering, e.g., node properties may be assessed with a pretrained neural network, thereby automating context generation. Furthermore, the computer system may provide efficient summarization. Notably, the process may dynamically integrate meaningful properties, while discarding unnecessary data.

We now describe different examples of the interaction between a user and the computer system while using the analysis techniques. Table 1 provides an example of the analysis techniques and, in particular, the interaction between a user and the computer system in response to a litigation-related query from the user. Moreover, Table 2 provides an example of generative software coding. Table 3 provides an example of a personalized campaign. Furthermore, Table 4 provides an example of adaptive medical records and recommendations. Table 5 provides an example of proactive issue resolution. Additionally, Table 6 provides an example of workflow automation. Table 7 provides an example of business strategy. Note that Table 8 provides an example of a token count with multi-operation storytelling. Tables 9 and 10 provide additional examples of interaction between a user and the computer system while using the analysis techniques.

TABLE 1
Operation 1: User Input
User Input: “Find cases where self-defense was used as an argument in civil liability claims.”
User Input Summarized: “Retrieve past legal cases involving self-defense in civil liability
claims.”
Operation 2: Named Entity Recognition (NER)
Entities Identified:
[Self-Defense] -> Legal Principle
[Civil Liability] -> Case Category
[Cases] -> Document Retrieval Type
Operation 3: Query Formulation and Execution
Generated Cypher Query:
MATCH (c:Case)-[:INVOLVES]->(d:Doctrine {name: “Self-Defense”})
WHERE c.category = “Civil Liability”
RETURN c.case_name, c.jurisdiction, c.year, c.outcome
LIMIT 10;
Operation 4: Database Search & Node Crawl
Node Crawl:
[Self-Defense Doctrine] -> [Linked Civil Liability Cases]
├ Case: “Doe v. Smith” (2020, CA) - Outcome: Defense Won
├ Case: “Johnson v. State” (2018, TX) - Outcome: Defense Lost
├ Case: “Anderson v. Blake” (2015, NY) - Outcome: Defense Won
Results from Database Summarized:
1. Doe v. Smith (2020, CA) - Defense Won
2. Johnson v. State (2018, TX) - Defense Lost
3. Anderson v. Blake (2015, NY) - Defense Won
Operation 5: Summarization and Context Storage
Summary from Database Added to Hidden Context:
[Hidden Context]:
- Self-defense case law retrieved (3 cases).
- 2 out of 3 cases ruled in favor of the defense.
Operation 6: Query Sent to LLM for Analysis
Hidden Context and Summarized User Query Sent to LLM:
User Query: “Find cases where self-defense was used as an argument in civil liability
claims.”
Context Provided:
- Doe v. Smith (2020, CA) - Defense Won
- Johnson v. State (2018, TX) - Defense Lost
- Anderson v. Blake (2015, NY) - Defense Won
LLM Responds with Relevant Answer:
“Self-defense has been successfully used in civil liability claims in 2 out of 3 cases retrieved.
In Doe v. Smith (2020, CA) and Anderson v. Blake (2015, NY), the defense successfully
argued that force was justified. However, in Johnson v. State (2018, TX), the court ruled
against the defense, emphasizing excessive force.”
Operation 7: LLM-Generated Information Stored Back in Database
New Information from LLM is Summarized:
[Doe v. Smith] -> [Key Ruling: Self-defense justified]
[Anderson v. Blake] -> [Key Ruling: Self-defense upheld]
[Johnson v. State] -> [Key Ruling: Excessive force led to loss]
New Information Written to Database:
MATCH (c:Case {case_name: “Doe v. Smith”})
SET c.key_ruling = “Self-defense justified”;
MATCH (c:Case {case_name: “Anderson v. Blake”})
SET c.key_ruling = “Self-defense upheld”;
MATCH (c:Case {case_name: “Johnson v. State”})
SET c.key_ruling = “Excessive force led to loss”;

```
TABLE 2
Operation 1: User Input
User Input: “Generate a Python function that fetches data from an API using requests and
adheres to internal logging standards.”
User Input Summarized: “Create a Python function for API data retrieval using requests with
integrated logging.”
Operation 2: Named Entity Recognition (NER)
Entities Identified:
[Python] -> Programming Language
[Function] -> Code Structure
[API] -> Concept (External Service Communication)
[Requests] -> Library Dependency
[Logging Standards] -> Internal Best Practices
Operation 3: Query Formulation and Execution
Generated Cypher Query:
MATCH (1:Library {name: “requests”})-[:HAS_VERSION]->(v: Version)
WHERE v.latest = true
WITH l, v
MATCH (s:Standard {name: “Logging”})-[:APPLIES_TO]->(c:CodeGuideline)
RETURN l.name, v.version, s.name, c.rule_text
Operation 4: Database Search & Node Crawl
Node Crawl:
[Requests Library] -> [Latest Version]
├ Version: “2.32.3”
[Logging Standards] -> [Internal Code Guidelines]
├ Rule: “Use structured JSON logs with timestamps.”
├ Rule: “Ensure all errors are logged at ERROR level.”
Results from Database Summarized:
1. Latest version of requests: 2.32.3
2. Logging requirements:
  - Structured JSON logs with timestamps
  - Errors logged at ERROR level
Operation 5: Summarization & Context Storage
Summary from Database Added to Hidden Context:
[Hidden Context]:
- Requests version 2.32.3 should be used
- Logging must be structured in JSON with timestamps
- Errors must be logged at ERROR level
Operation 6: Query Sent to LLM for Code Generation
Hidden Context and Summarized User Query Sent to LLM:
User Query: “Generate a Python function that fetches data from an API using requests and
adheres to internal logging standards.”
Context Provided:
- Use requests 2.32.3 for API calls
- Implement structured JSON logs with timestamps
- Ensure errors are logged at ERROR level
LLM Responds with Relevant Code:
...
import requests
import json
import logging
logging.basicConfig(level=logging.INFO, format=‘%(asctime)s - %(levelname)s - %
(message)s’)
def fetch_api_data(url):
  “““Fetches data from an API while adhering to internal logging standards.”””
  try:
    response = requests.get(url)
    response.raise_for_status( )
    data = response.json( )
    logging.info(json.dumps({“event”: “API Request Successful”, “url”: url, “status”:
response.status_code}))
    return data
  except requests.exceptions.RequestException as e:
    logging.error(json.dumps({“event”: “API Request Failed”, “url”: url, “error”: str(e)}))
    return None
...
Operation 7: LLM-Generated Code Stored Back in Database
New Information from LLM is Summarized:
[Function fetch_api_data] -> [Uses requests 2.32.3]
[Logging] -> [JSON format with timestamps]
[Error Handling] -> [RequestsException captured]
New Information Written to Database:
MATCH (f:Function {name: “fetch_api_data”})
SET f.uses_library = “requests 2.32.3”,
  f.logging_standard = “JSON format with timestamps”,
  f.error_handling = “RequestsException captured”;
```

```
TABLE 3
Operation 1: User Input
User Input: “Generate a personalized email campaign for a customer who recently browsed
running shoes and follows marathon events.”
User Input Summarized: “Create a dynamic email campaign for a user interested in running
shoes and marathon events.”
Operation 2: Named Entity Recognition (NER)
Entities Identified:
[Personalized Email Campaign] -> Marketing Strategy
[Customer] -> Individual Profile
[Running Shoes] -> Product Category
[Marathon Events] -> Interest Category
Operation 3: Query Formulation and Execution
Generated Cypher Query:
MATCH (c:Customer)-[:INTERESTED_IN]->(p:ProductCategory {name: “Running
Shoes”})
MATCH (c)-[:ENGAGES_WITH]->(e:EventCategory {name: “Marathon Events”})
WITH c
MATCH (r:Recommendation)-[:RELEVANT_TO]->(p)
RETURN c.name, p.name, e.name, r.product, r.message
Operation 4: Database Search & Node Crawl
Node Crawl:
[Customer] -> [Running Shoes Interest]
├ Browsing History: “Nike Air Zoom Pegasus, Adidas Ultraboost”
[Customer] -> [Marathon Events Engagement]
├ Followed: “Boston Marathon, NYC Marathon”
[Product Recommendations] -> [Based on Interests]
├ Nike Air Zoom Pegasus - “Optimized for marathon runners”
├ Adidas Ultraboost - “Designed for long-distance comfort”
Results from Database Summarized:
1. Customer recently browsed Nike Air Zoom Pegasus and Adidas Ultraboost
2. Customer follows Boston Marathon and NYC Marathon
3. Recommended products: Nike Air Zoom Pegasus, Adidas Ultraboost
4. Suggested messaging:
  - “Optimized for marathon runners”
  - “Designed for long-distance comfort”
Operation 5: Summarization & Context Storage
Summary from Database Added to Hidden Context:
[Hidden Context]:
- Customer interested in running shoes (Nike Air Zoom Pegasus, Adidas Ultraboost)
- Follows major marathon events (Boston, NYC)
- Suggested messaging based on product fit for marathons
Operation 6: Query Sent to LLM for Personalized Campaign Creation
Hidden Context and Summarized User Query Sent to LLM:
User Query: “Generate a personalized email campaign for a customer who recently browsed
running shoes and follows marathon events.”
Context Provided:
- Customer browsed Nike Air Zoom Pegasus, Adidas Ultraboost
- Follows Boston Marathon, NYC Marathon
- Recommended messaging based on marathon-focused shoe benefits
LLM Responds with Relevant Personalized Email:
```
Subject: Take Your Runs to the Next Level!
Hi [Customer's Name],
We noticed you're gearing up for marathon season! Whether you're training for the Boston
Marathon or setting your sights on NYC, the right gear can make all the difference.
[running emoji] Nike Air Zoom Pegasus - Engineered for marathon performance, delivering
energy return with every stride.
[running emoji] Adidas Ultraboost - Designed for maximum comfort over long distances,
helping you push further.
As a valued runner, we're offering 10% off your next purchase to help you hit the pavement
with confidence.
Claim your exclusive offer now → [Shop Now]
See you at the finish line!
The [Brand Name] Team
```
Operation 7: LLM-Generated Content Stored Back in Database
New Information from LLM is Summarized:
[Campaign] -> [Nike Air Zoom Pegasus, Adidas Ultraboost Promotion]
[Personalization] -> [Mentions Customer's Interest in Marathon Events]
[Offer] -> [10% Discount]
New Information Written to Database:
MATCH (c:Campaign {name: “Marathon Runner Email”})
SET c.target_products = [“Nike Air Zoom Pegasus”, “Adidas Ultraboost”],
  c.personalization = “Mentions Marathon Interest”,
  c.discount_offer = “10%”;
```

```
TABLE 4
Operation 1: User Input
User Input: “Recommend a treatment plan for a patient diagnosed with Stage II lung cancer
who has a history of hypertension and is allergic to cisplatin.”
User Input Summarized: “Generate a personalized treatment recommendation for a Stage II
lung cancer patient with hypertension and cisplatin allergy.”
Operation 2: Named Entity Recognition (NER)
Entities Identified:
[Patient] -> Individual Medical Profile
[Stage II Lung Cancer] -> Diagnosis
[Hypertension] -> Comorbidity
[Cisplatin Allergy] -> Medication Sensitivity
[Treatment Plan] -> Medical Recommendation
Operation 3: Query Formulation and Execution
Generated Cypher Query:
MATCH (p:Patient)-[:DIAGNOSED_WITH]->(d:Disease {name: “Stage II Lung Cancer”})
MATCH (p)-[:HAS_CONDITION]->(c:Comorbidity {name: “Hypertension”})
MATCH (p)-[:ALLERGIC_TO]->(m:Medication {name: “Cisplatin”})
WITH p
MATCH (t: Treatment)-[:RECOMMENDED_FOR]->(d)
WHERE NOT (t)-[:CONTAINS]->(m)
RETURN p.name, d.name, c.name, t.name, t.success_rate, t.research_link
Operation 4: Database Search & Node Crawl
Node Crawl:
[Patient] -> [Diagnosis: Stage II Lung Cancer]
├ Comorbidity: Hypertension
├ Allergy: Cisplatin
[Stage II Lung Cancer] -> [Available Treatments]
├ Chemotherapy: “Cisplatin + Pemetrexed” (Not Recommended - Contains Cisplatin)
├ Targeted Therapy: “Osimertinib” (Recommended - Effective in EGFR-positive cases)
├ Immunotherapy: “Pembrolizumab” (Recommended - Effective for PD-L1 expression
>50%)
Results from Database Summarized:
1. Patient has Stage II lung cancer with hypertension and a cisplatin allergy.
2. Cisplatin-based chemotherapy should be avoided.
3. Recommended treatments:
  - Osimertinib (Effective for EGFR-positive lung cancer)
  - Pembrolizumab (Effective if PD-L1 expression >50%)
Operation 5: Summarization & Context Storage
Summary from Database Added to Hidden Context:
[Hidden Context]:
- Patient diagnosed with Stage II lung cancer.
- Comorbidity: Hypertension.
- Allergy: Cisplatin (avoid cisplatin-based chemotherapy).
- Alternative treatments: Osimertinib (EGFR-positive) and Pembrolizumab (PD-L1 >50%).
Operation 6: Query Sent to LLM for Personalized Treatment Recommendation
Hidden Context and Summarized User Query Sent to LLM:
User Query: “Recommend a treatment plan for a patient diagnosed with Stage II lung cancer
who has a history of hypertension and is allergic to cisplatin.”
Context Provided:
- Diagnosis: Stage II lung cancer
- Comorbidity: Hypertension
- Allergy: Cisplatin
- Alternative treatments: Osimertinib (EGFR-positive) and Pembrolizumab (PD-L1 >50%)
LLM Responds with Relevant Treatment Recommendation:
“Given the patient's diagnosis of Stage II lung cancer, history of hypertension, and allergy to
cisplatin, it is recommended to avoid standard platinum-based chemotherapy. Instead,
molecular testing should be conducted to determine if the patient is EGFR-positive or has
high PD-L1 expression.
1. Osimertinib: If the patient has an EGFR mutation, Osimertinib is a preferred targeted
therapy with high efficacy and manageable side effects.
2. Pembrolizumab: If PD-L1 expression is greater than 50%, Pembrolizumab is a
recommended first-line immunotherapy option.
3. Alternative Chemotherapy Regimen: A non-platinum-based chemotherapy such as
Paclitaxel combined with Bevacizumab may be considered if neither of the above options is
viable.”
Operation 7: LLM-Generated Information Stored Back in Database
New Information from LLM is Summarized:
[Stage II Lung Cancer] -> [Recommended Treatment: Osimertinib (EGFR+), Pembrolizumab
(PD-L1 >50%)]
[Patient] -> [Requires Molecular Testing for EGFR and PD-L1]
[Alternative Treatment] -> [Paclitaxel + Bevacizumab (Non-Platinum Chemotherapy)]
New Information Written to Database:
MATCH (d:Disease {name: “Stage II Lung Cancer”})
SET d.recommended_treatments = [“Osimertinib (EGFR+)”, “Pembrolizumab (PD-L1
>50%)”, “Paclitaxel + Bevacizumab”];
MATCH (p:Patient {name: “Patient X”})
SET p.requires_testing = [“EGFR Mutation Test”, “PD-L1 Expression Test”];
```

```
TABLE 5
Operation 1: User Input
User Input: “Identify potential service disruptions for customers experiencing slow internet
speeds and provide a proactive resolution.”
User Input Summarized: “Detect slow internet service issues and recommend proactive
resolutions.”
Operation 2: Named Entity Recognition (NER)
Entities Identified:
[Customer] -> Service Subscriber
[Internet Speed] -> Service Metric
[Service Disruptions] -> Issue Type
[Resolution] -> Recommended Action
Operation 3: Query Formulation and Execution
Generated Cypher Query:
MATCH (c:Customer)-[:HAS_SERVICE]->(s:Service {type: “Internet”})
MATCH (c)-[:REPORTED_ISSUE]->(i:Issue {type: “Slow Speed”})
WITH c, s, i
MATCH (n:NetworkNode)-[:AFFECTS]->(s)
WHERE n.status = “Degraded”
RETURN c.name, s.plan, i.type, n.location, n.status, n.estimated_fix_time
Operation 4: Database Search & Node Crawl
Node Crawl:
[Customer] -> [Service: Internet]
├ Plan: “Fiber 500 Mbps”
├ Reported Issue: Slow Speed
[Network Node] -> [Degraded Performance]
├ Location: “New York City - Central Hub”
├ Estimated Fix Time: “2 hours”
Results from Database Summarized:
1. Customers with Fiber 500 Mbps plans in NYC are experiencing slow speeds.
2. Root cause identified: Network degradation at central hub.
3. Estimated resolution time: 2 hours.
Operation 5: Summarization & Context Storage
Summary from Database Added to Hidden Context:
[Hidden Context]:
- Customers in NYC with Fiber 500 Mbps plans are affected by slow speeds.
- Issue traced to degraded network performance at the central hub.
- Estimated fix time: 2 hours.
Operation 6: Query Sent to LLM for Proactive Customer Notification
Hidden Context and Summarized User Query Sent to LLM:
User Query: “Identify potential service disruptions for customers experiencing slow internet
speeds and provide a proactive resolution.”
Context Provided:
- Customers with Fiber 500 Mbps plans in NYC report slow speeds.
- Network degradation detected at central hub.
- Estimated resolution time: 2 hours.
LLM Responds with Relevant Customer Notification:
“Dear Customer,
We've detected a temporary slowdown in your internet service due to network congestion at
our central hub in NYC. Our engineers are actively working on resolving the issue, and we
expect full service restoration within the next 2 hours.
In the meantime, you can try these operations for a smoother experience:
1. Restart your modem and router to refresh your connection.
2. Use a wired connection for critical activities.
3. Limit high-bandwidth usage during peak hours.
We appreciate your patience and are committed to keeping you connected.
Thank you,
[Telecom Provider] Support Team”
Operation 7: LLM-Generated Information Stored Back in Database
New Information from LLM is Summarized:
[Service Issue] -> [Degraded Network Performance - NYC]
[Affected Customers] -> [Fiber 500 Mbps Plan Subscribers]
[Resolution] -> [Fix in 2 Hours, Temporary Workarounds Suggested]
New Information Written to Database:
MATCH (i:Issue {type: “Slow Speed”, location: “New York City”})
SET i.estimated_resolution_time = “2 hours”,
  i.customer_notification_sent = true,
  i.recommended_actions = [“Restart modem”, “Use wired connection”, “Limit high-
bandwidth usage”];
```

```
TABLE 6
Operation 1: User Input
User Input: “Automate IT ticket management by prioritizing and resolving issues based on
real-time updates and historical patterns.”
User Input Summarized: “Optimize IT ticket processing using real-time updates and past
resolution data.”
Operation 2: Named Entity Recognition (NER)
Entities Identified:
[IT Ticket] -> Support Request
[Issue Priority] -> Severity Classification
[Real-Time Updates] -> Dynamic Status Monitoring
[Historical Patterns] -> Data-Driven Decision Making
Operation 3: Query Formulation and Execution
Generated Cypher Query:
MATCH (t: Ticket)-[:HAS_CATEGORY]->(c:IssueType)
MATCH (t)-[:ASSIGNED_TO]->(g:SupportGroup)
MATCH (t)-[:HAS_PRIORITY]->(p:PriorityLevel)
WITH t, c, g, p
MATCH (h:HistoricalResolution)-[:RESOLVED_ISSUE]->(c)
WHERE h.success_rate > 80
RETURN t.id, c.name, g.name, p.level, h.average_resolution_time, h.best_practice_solution
Operation 4: Database Search & Node Crawl
Node Crawl:
[Open IT Tickets] -> [Issue Categories]
├ Ticket ID: #15234
| ├ Category: “Network Outage”
| ├ Assigned Group: “Network Support Team”
| ├ Priority: High
[Historical Data] -> [Resolution Patterns]
├ Issue: “Network Outage”
| ├ Average Resolution Time: 3 hours
| ├ Best Practice Solution: “Restart affected routers, reconfigure load balancer”
Results from Database Summarized:
1. Open IT tickets classified by category and priority.
2. Network Support Team assigned to high-priority network outage issues.
3. Historical resolutions indicate a 3-hour average resolution time for similar outages.
4. Recommended best practice: Restart routers, reconfigure load balancer.
Operation 5: Summarization & Context Storage
Summary from Database Added to Hidden Context:
[Hidden Context]:
- IT Ticket #15234: High-priority network outage assigned to Network Support Team.
- Historical resolution data: Similar issues resolved in 3 hours using predefined operations.
- Suggested workflow: Automate ticket escalation and apply recommended solution.
Operation 6: Query Sent to LLM for Workflow Automation Recommendation
Hidden Context and Summarized User Query Sent to LLM:
User Query: “Automate IT ticket management by prioritizing and resolving issues based on
real-time updates and historical patterns.”
Context Provided:
- High-priority network outage assigned to Network Support Team.
- Past resolution data suggests a 3-hour fix time.
- Recommended actions: Restart routers, reconfigure load balancer.
LLM Responds with Optimized Workflow Automation:
“To enhance IT ticket resolution, the following automation operations can be applied:
1. Immediate Ticket Escalation: Because this is a high-priority network outage, notify the
Network Support Team via email and internal chat.
2. Automated Initial Resolution: Execute a pre-configured network diagnostic script to
identify failing nodes and attempt a remote router restart.
3. Dynamic Workflow Adjustment: If the automated restart fails, escalate the issue to a Level
2 technician and notify affected users with an estimated resolution time.
4. Historical Best Practices Applied: Reconfigure the load balancer if network bottlenecks are
detected.
Estimated time to resolution: 3 hours based on past cases.”
Operation 7: LLM-Generated Workflow Updates Stored Back in Database
New Information from LLM is Summarized:
[IT Ticket #15234] -> [Priority: High, Assigned: Network Support Team]
[Automation Operations] -> [Immediate Escalation, Network Diagnostics, Remote Restart,
Load Balancer Reconfiguration]
[Estimated Resolution Time] -> [3 Hours]
New Information Written to Database:
MATCH (t: Ticket {id: 15234})
SET t.automation_operations = [“Immediate Escalation”, “Network Diagnostics”, “Remote
Restart”, “Load Balancer Reconfiguration”],
  t.estimated_resolution_time = “3 hours”,
  t.status = “In Progress - Automated”;
```

```
TABLE 7
Operation 1: User Input
User Input: “What is the best approach to increase revenue next quarter given our current
budget constraints and strategic objectives?”
User Input Summarized: “Analyze revenue growth strategies based on budget constraints and
strategic goals.”
Operation 2: Named Entity Recognition (NER)
Entities Identified:
[Revenue Growth] -> Business Objective
[Budget Constraints] -> Financial Limitation
[Strategic Objectives] -> Company Goals
[Next Quarter] -> Timeframe
Operation 3: Query Formulation and Execution
Generated Cypher Queries:
Query for Budget Information:
MATCH (b:Budget)-[:APPLIES_TO]->(q:Quarter {name: “Q2 2024”})
RETURN b.total_allocation, b.remaining_funds, b.spending_limits
Query for Strategic Objectives:
MATCH (s:Strategy)-[:FOR_TIMEFRAME]->(q:Quarter {name: “Q2 2024”})
RETURN s.goal, s.key_initiatives
Query for Revenue Trends:
MATCH (r:Revenue)-[:RECORDED_IN]->(p:PastQuarter)
WHERE p.year >= 2023
RETURN r.quarter, r.total_revenue, r.growth_rate
Operation 4: Database Search & Node Crawl
[Budget Documents] -> [Current Quarter Budget]
├ Total Allocation: $5,000,000
├ Remaining Funds: $1,200,000
├ Spending Limits: “Max $500,000 per initiative”
[Strategic Objectives] -> [Current Business Goals]
├ Goal: “Expand digital advertising presence”
├ Key Initiatives: “Invest in targeted social media campaigns, Improve SEO, Partner with
influencers”
[Revenue Trends] -> [Past Growth Performance]
├ Q1 2023 Revenue: $10,000,000 (+5% growth)
├ Q2 2023 Revenue: $10,500,000 (+4% growth)
├ Q3 2023 Revenue: $11,000,000 (+4.8% growth)
├ Q4 2023 Revenue: $11,300,000 (+2.7% growth)
Results from Database Summarized:
1. Budget available: $1,200,000 with a $500,000 per initiative limit.
2. Strategic focus: Digital advertising expansion via social media, SEO, and influencers.
3. Past revenue trends indicate slowing growth (from 5% in Q1 2023 to 2.7% in Q4 2023).
Operation 5: Summarization & Context Storage
Summary from Database Added to Hidden Context:
[Hidden Context]:
- Budget constraints: $1,200,000 remaining, $500,000 cap per initiative.
- Strategic focus: Increase digital ad presence through targeted campaigns.
- Revenue growth has slowed in recent quarters, requiring higher-impact strategies.
Operation 6: Query Sent to LLM for Strategic Recommendation
Hidden Context and Summarized User Query Sent to LLM:
User Query: “What is the best approach to increase revenue next quarter given our current
budget constraints and strategic objectives?”
Context Provided:
- Budget: $1,200,000 remaining, $500,000 per initiative.
- Strategic focus: Expand digital presence via social media, SEO, influencers.
- Revenue growth slowing (5% to 2.7% over past four quarters).
LLM Responds with Recommended Business Strategy:
“Given your available budget and strategic focus, I recommend the following revenue-
boosting initiatives:
1. Targeted Social Media Ads ($500,000)
  - Focus on high-engagement platforms (Instagram, TikTok).
  - Utilize retargeting ads to convert past visitors.
  - Estimated ROI: 10-15% increase in Q2 revenue.
2. SEO Optimization & Content Strategy ($400,000)
  - Invest in AI-generated SEO-optimized content.
  - Improve page load speeds and mobile optimization.
  - Estimated ROI: 7-10% increase in organic traffic.
3. Influencer Partnerships ($300,000)
  - Partner with micro-influencers in key demographics.
  - Focus on product placement and long-term ambassador deals.
  - Estimated ROI: 8-12% increase in brand engagement.
Projected revenue growth: 7-10% in Q2 2024.”
Operation 7: LLM-Generated Strategy Stored Back in Database
New Information from LLM is Summarized:
[Q2 2024 Strategy] -> [Digital Ad Expansion, SEO Growth, Influencer Partnerships]
[Budget Allocation] -> [$500K Social Ads, $400K SEO, $300K Influencers]
[Projected Revenue Growth] -> [7-10%]
New Information Written to Database:
MATCH (q:Quarter {name: “Q2 2024”})
SET q.recommended_initiatives = [“Social Ads ($500K)”, “SEO Optimization ($400K)”,
“Influencer Partnerships ($300K)”],
  q.projected_growth = “7-10%”;
```

TABLE 8
Operation 1: User Input
User Input: “I walk into the tavern and look around. What do I see?”
User Input Summarized: “User enters the tavern and observes surroundings.”
Operation 2: Named Entity Recognition (NER)
Entities Identified:
[User] -> Player Character
[Tavern] -> Location
[Observing Surroundings] -> Action
Operation 3: Query Formulation and Execution
Generated Cypher Query:
MATCH (t: Tavern)-[:HAS_OCCUPANTS]->(p:Patron)
MATCH (t)-[:HAS_DETAILS]->(d:Description)
RETURN t.name, d.ambiance, p.count, p.mood
Operation 4: Database Search & Node Crawl
[Tavern] -> [Environment Details]
├ Name: “The Rusty Mug”
├ Ambiance: “Dimly lit, smell of ale, chatter of patrons”
[Tavern] -> [Patrons Present]
├ Number of Patrons: 6
├ Mood: Relaxed, casual conversation
Results from Database Summarized:
1. User is inside “The Rusty Mug.”
2. The tavern is dimly lit, smells of ale, and has a lively but relaxed crowd.
3. Six patrons are scattered around, chatting casually.
Operation 5: Summarization & Context Storage
Summary from Database Added to Model Prompt:
[Model Prompt]:
- System Instructions: Role-playing mechanics, world consistency rules, narrative style
guidance.
- User Preferences: Interaction style, previous world knowledge, recurring NPC references.
- World State: Major locations, characters, unresolved quests, known historical events.
- Immediate Context: User enters “The Rusty Mug,” which is dimly lit, smells of ale, and has
six patrons engaged in casual conversation.
Hidden Context and Summarized User Query Sent to LLM
LLM Responds:
“The tavern is dimly lit, filled with the scent of aged ale. A few groups of patrons are
scattered at wooden tables, engaged in quiet conversation. The bartender wipes a mug behind
the bar, occasionally glancing at new arrivals.”
Operation 6: New Information Written to Database
[Tavern] -> [Observed Details: “Bartender behind the bar, patrons at tables.”]
- Estimated Token Count this Turn
- Current Turn Window: approximately 250 tokens
- Model Prompt: approximately 4,000 tokens
- CM Processed Tokens: approximately 4,250 tokens
- Standard LLM Context: approximately 4,250 tokens

TABLE 9
Operation 1: User Input
User Input: “I ask the bartender if he's heard of any missing persons lately.”
User Input Summarized: “User inquires about missing persons.”
Operation 2: Named Entity Recognition (NER)
Entities Identified:
[User] -> Player Character
[Bartender] -> NPC
[Missing Persons] -> Investigation Topic
Operation 3: Query Formulation and Execution
Generated Cypher Query:
MATCH (t:Tavern)-[:HAS_OCCUPANT]->(b:Bartender)
MATCH (m:MissingPerson)-[:MENTIONED_IN]->(t)
RETURN b.name, m.case_details
Operation 4: Database Search & Node Crawl
[Tavern] -> [Bartender Information]
├ Name: “Garret”
[Missing Persons Cases] -> [Linked to Tavern]
├ Case: “Young man named Ral missing, last seen at the tavern two nights ago.”
Results from Database Summarized:
1. Bartender Garret serves at “The Rusty Mug.”
2. Garret recalls a missing person case-Ral, last seen two nights ago.
Operation 5: Summarization & Context Storage
Summary from Database Added to Model Prompt:
[Model Prompt]:
- System Instructions: Narrative coherence, dynamic response handling, memory constraints.
- User Preferences: Persistent investigative approach, preferred pacing.
- World State: Active storylines, NPC reputations, regional conflicts, player decisions.
- Immediate Context: User inquires about missing persons, bartender Garret recalls Ral
missing two nights ago.
Hidden Context and Summarized User Query Sent to LLM
LLM Responds:
“Garret sets down the mug he was cleaning and narrows his eyes. ‘Ral? Yeah, he was here a
couple nights ago. Seemed nervous. Left in a hurry, didn't say where he was going.’”
Operation 6: New Information Written to Database
[Missing Persons Case] -> [Ral Last Seen: “Two nights ago, left in a hurry.”]
- Estimated Token Count this Turn
- Current Turn Window: approximately 400 tokens
- Model Prompt: approximately 4,000 tokens
- CM Processed Tokens: approximately 4,400 tokens
- Standard LLM Context: approximately 53,500 tokens

TABLE 10
Operation 1: User Input
User Input: “I've tracked Ral to an abandoned mill outside town. Does anything seem off
about this place?”
User Input Summarized: “User examines abandoned mill for suspicious activity.”
Operation 2: Named Entity Recognition (NER)
Entities Identified:
[User] -> Player Character
[Abandoned Mill] -> Location
[Examining] -> Action
Operation 3: Query Formulation and Execution
Generated Cypher Query:
MATCH (m:Mill)-[:HAS_FEATURE]->(f:Observation)
MATCH (m)-[:HAS_HISTORY]->(h:Event)
RETURN f.details, h.recent_activity
Operation 4: Database Search & Node Crawl
[Abandoned Mill] -> [Environmental Details]
├ Exterior: “Old wooden structure, broken windows, vines growing on the walls.”
[Recent Activity] -> [Unusual Sightings]
├ “Torchlight seen inside last night.”
├ “Footprints in the mud leading to the entrance.”
Results from Database Summarized:
1. The abandoned mill is in disrepair broken windows, vines, aged wood.
2. Last night, torchlight was spotted inside.
3. Fresh footprints indicate recent activity.
Operation 5: Summarization & Context Storage
Summary from Database Added to Model Prompt:
[Model Prompt]:
- System Instructions: Maintain narrative continuity, prioritize key details, enforce logical
consequences.
- User Preferences: Strong focus on investigation, detailed environmental descriptions.
- World State: Prior locations visited, NPC interactions, open investigations.
- Immediate Context: User examines abandoned mill, which shows signs of recent activity-
torchlight and fresh footprints.
Hidden Context and Summarized User Query Sent to LLM
LLM Responds:
“As you approach the abandoned mill, the old wooden boards creak under your weight. The
place looks deserted, but the faint smell of burning wood lingers in the air. Through the
broken windows, you catch a glimpse of movement-someone is inside.”
Operation 6: New Information Written to Database
[Abandoned Mill] -> [Suspicious Observations: “Faint smell of burning wood, movement
inside.”]
- Estimated Token Count this Turn
- Current Turn Window: approximately 500 tokens
- Model Prompt: approximately 4,000 tokens
- CM Processed Tokens: approximately 4,500 tokens
- Standard LLM Context: approximately 503,500 tokens

Regarding the context window efficiency in these examples, note that for each turn the computer system may retain only the necessary contextual details, thereby avoiding loss of coherence. The model prompt from the LLM (approximately 4,000 tokens) may ensure static reference knowledge, thereby keeping world mechanics, story structure, and persistent elements in memory. Moreover, the total token processing may remain stable (approximately 4,000 plus the current turn) rather than growing exponentially, thereby ensuring cost-effective and efficient usage. Furthermore, existing or standard LLM Context models may be computationally prohibitive at the scales shown, while the computer system maintains real-time adaptation while preserving accuracy and efficiency.

We now provide some definitions used in the present discussion. An ‘adaptive context window’ may include two distinct processing layers used by the computer system to manage user interaction. The visible context window may contain the immediate interaction content presented to the user. The hidden context window may include contextually relevant data retrieved from the knowledge database to generate responses. This layer may be dynamically adjusted based at least in part on query complexity and relevance.

Moreover, in the present discussion, a ‘graph database’ may include a database system that represents entities (nodes) and their relationships (edges) in a graph structure. In this invention, the graph database may be adaptive and dynamically update its schema, nodes, and edges in real time, enabling efficient storage and retrieval of interconnected data.

Furthermore, in the present discussion, ‘contextual node crawling’ may include a process of traversing nodes and edges within the graph database to retrieve the most-relevant information. Nodes and edges may be prioritized based at least in part on relevance scoring, which may evaluate their importance to the current query or context.

Additionally, in the present discussion, ‘relevance filtering’ may include techniques used to evaluate and prioritize retrieved data based at least in part on its importance to the user's query. Irrelevant or redundant information may be excluded, thereby helping to ensure the language model processes only concise and meaningful data.

Note that, in the present discussion, a ‘push-and-pull graph system’ may include a push mechanism that provides a process by which new information generated during an interaction is analyzed, structured, and stored into the graph database, and a pull mechanism that provides a process of retrieving relevant data from the graph database for inclusion in the hidden context window during query processing.

Moreover, in the present discussion, ‘dynamic knowledge integration’ may include a process of continuously analyzing, summarizing, and incorporating new information into the graph database during and after interactions. This may ensure that the knowledge base evolves and remains up-to-date without manual intervention.

Furthermore, in the present discussion, ‘distributed language model agents’ may include a set of smaller, specialized AI components working in parallel to handle distinct tasks (e.g., query parsing, summarization, and/or database interaction). These agents may collaborate to produce a coherent output without requiring a single monolithic language model.

Additionally, in the present discussion, ‘entity recognition and expansion’ may include a process by which the computer system identifies key entities (e.g., people, objects, and/or concepts) within a user query and expands their context by associating them with related entities, properties, and/or relationships in the graph database.

Note that, in the present discussion, a ‘summarization model’ may include a component of the computer system that condenses retrieved data into concise, readable formats suitable for inclusion in the hidden context window. This may help ensure that only relevant information is presented to the language model for response generation.

Moreover,, in the present discussion, ‘freeform data ingestion’ may include a process in which the computer system interprets and processes structured or unstructured input data (e.g., documents, databases, text files, etc.) to dynamically generate an initial knowledge graph. The computer system may use a pretrained neural network to identify entities, relationships, and/or properties from the ingested data.

Furthermore, in the present discussion, a ‘knowledge evolution loop’ may include a continuous cycle in which the computer system: retrieves and uses existing knowledge to respond to queries; identifies and integrates new knowledge from interactions; and/or updates the graph database to reflect the added information for future interactions.

Additionally, in the present discussion, a ‘hidden context’ may include contextual information retrieved from the graph database and used internally by the system to formulate responses. This data may not be visible to the user, but may serve as the basis for generating accurate and relevant output. Moreover, in the present discussion, a ‘visible context’ may include the direct content of the interaction that is presented to the user, such as their query and the response from the computer system and/or the pretrained neural network. This is distinct from the hidden context, which may operate behind the scenes.

Furthermore, in the present discussion, a ‘dynamic schema definition’ may include the ability of the computer system to autonomously define and adjust the structure of its graph database based at least in part on the data it ingests. This may include identifying new entity types, attributes, and/or relationships as required by the domain or input data.

Additionally, in the present discussion, ‘real-time adaptation’ may include the capability of the computer system to respond to new queries, incorporate new knowledge, and/or adjust its operations dynamically during active interactions. This may help ensure that the computer system remains relevant and responsive without requiring offline updates or retraining.

Note that, in the present discussion, a ‘query transformation’ may include the process of refining and expanding a user's query (or input vector) into a structured format suitable for database retrieval. This may include identifying implicit and explicit entities and generating optimized database queries.

Moreover, in the present discussion, a ‘plug-and-play system’ may include a design that allows for seamless integration into existing workflows or language model frameworks. The analysis techniques may function autonomously, requiring minimal configuration or expertise from the user to operate.

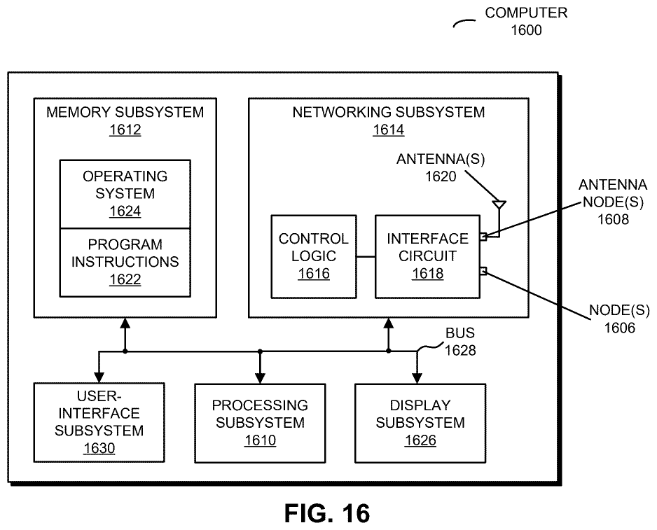

We now describe embodiments of a computer, which may perform at least some of the operations in the analysis techniques. FIG. 16 presents a block diagram illustrating an example of a computer 1600, e.g., in a computer system (such as computer system 100 in FIG. 1), in accordance with some embodiments. For example, computer 1600 may include: one of computers 110. This computer may include processing subsystem 1610, memory subsystem 1612, and networking subsystem 1614. Processing subsystem 1610 includes one or more devices configured to perform computational operations. For example, processing subsystem 1610 can include one or more microprocessors, ASICs, microcontrollers, programmable-logic devices, GPUs and/or one or more DSPs. Note that a given component in processing subsystem 1610 are sometimes referred to as a ‘computation device’.

Memory subsystem 1612 includes one or more devices for storing data and/or instructions for processing subsystem 1610 and networking subsystem 1614. For example, memory subsystem 1612 can include dynamic random access memory (DRAM), static random access memory (SRAM), and/or other types of memory. In some embodiments, instructions for processing subsystem 1610 in memory subsystem 1612 include: program instructions or sets of instructions (such as program instructions 1622 or operating system 1624), which may be executed by processing subsystem 1610. Note that the one or more computer programs or program instructions may constitute a computer-program mechanism. Moreover, instructions in the various program instructions in memory subsystem 1612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1610.

In addition, memory subsystem 1612 can include mechanisms for controlling access to the memory. In some embodiments, memory subsystem 1612 includes a memory hierarchy that comprises one or more caches coupled to a memory in computer 1600. In some of these embodiments, one or more of the caches is located in processing subsystem 1610.

In some embodiments, memory subsystem 1612 is coupled to one or more high-capacity mass-storage devices (not shown). For example, memory subsystem 1612 can be coupled to a magnetic or optical drive, a solid-state drive, or another type of mass-storage device. In these embodiments, memory subsystem 1612 can be used by computer 1600 as fast-access storage for often-used data, while the mass-storage device is used to store less frequently used data.

Networking subsystem 1614 includes one or more devices configured to couple to and communicate on a wired and/or wireless network (i.e., to perform network operations), including: control logic 1616, an interface circuit 1618 and one or more antennas 1620 (or antenna elements). (While FIG. 16 includes one or more antennas 1620, in some embodiments computer 1600 includes one or more nodes, such as antenna nodes 1608, e.g., a metal pad or a connector, which can be coupled to the one or more antennas 1620, or nodes 1606, which can be coupled to a wired or optical connection or link. Thus, computer 1600 may or may not include the one or more antennas 1620. Note that the one or more nodes 1606 and/or antenna nodes 1608 may constitute input(s) to and/or output(s) from computer 1600.) For example, networking subsystem 1614 can include a BluetoothTM networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 1614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, computer 1600 may use the mechanisms in networking subsystem 1614 for performing simple wireless communication between electronic devices, e.g., transmitting advertising or beacon frames and/or scanning for advertising frames transmitted by other electronic devices.

Within computer 1600, processing subsystem 1610, memory subsystem 1612, and networking subsystem 1614 are coupled together using bus 1628. Bus 1628 may include an electrical, optical, and/or electro-optical connection that the subsystems can use to communicate commands and data among one another. Although only one bus 1628 is shown for clarity, different embodiments can include a different number or configuration of electrical, optical, and/or electro-optical connections among the subsystems.

In some embodiments, computer 1600 includes a display subsystem 1626 for displaying information on a display, which may include a display driver and the display, such as a liquid-crystal display, a multi-touch touchscreen, etc. Moreover, computer 1600 may include a user-interface subsystem 1630, such as: a mouse, a keyboard, a trackpad, a stylus, a voice-recognition interface, and/or another human-machine interface.

Computer 1600 can be (or can be included in) any electronic device with at least one network interface. For example, computer 1600 can be (or can be included in): a desktop computer, a laptop computer, a subnotebook/netbook, a server, a supercomputer, a tablet computer, a smartphone, a cellular telephone, a consumer-electronic device, a portable computing device, communication equipment, and/or another electronic device.

Although specific components are used to describe computer 1600, in alternative embodiments, different components and/or subsystems may be present in computer 1600. For example, computer 1600 may include one or more additional processing subsystems, memory subsystems, networking subsystems, and/or display subsystems. Additionally, one or more of the subsystems may not be present in computer 1600. Moreover, in some embodiments, computer 1600 may include one or more additional subsystems that are not shown in FIG. 16. Also, although separate subsystems are shown in FIG. 16, in some embodiments some or all of a given subsystem or component can be integrated into one or more of the other subsystems or component(s) in computer 1600. For example, in some embodiments program instructions 1622 are included in operating system 1624 and/or control logic 1616 is included in interface circuit 1618.

Moreover, the circuits and components in computer 1600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1614 and/or computer 1600. The integrated circuit may include hardware and/or software mechanisms that are used for transmitting signals from computer 1600 and receiving signals at computer 1600 from other electronic devices. Aside from the mechanisms herein described, radios are generally known in the art and hence are not described in detail. In general, networking subsystem 1614 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the analysis techniques may be implemented using program instructions 1622, operating system 1624 (such as a driver for interface circuit 1618) or in firmware in interface circuit 1618. Thus, the analysis techniques may be implemented at runtime of program instructions 1622. Alternatively or additionally, at least some of the operations in the analysis techniques may be implemented in a physical layer, such as hardware in interface circuit 1618.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the analysis techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device;
a computation device coupled to the interface circuit;
memory, coupled to the computation device, storing program instructions, wherein, when executed by the computation device, the program instructions cause the computer system to perform one or more operations comprising:
receiving, from the electronic device, an input vector;
accessing, in a graph database, information specifying a context associated with the input vector;
determining a dynamic content window based at least in part on the context, wherein the dynamic content window specifies a subset of content in the input vector, and the dynamic content window has a length less than a predefined value;
providing, to a pretrained neural network, the input vector and the dynamic content window;
receiving, from the pretrained neural network, a response vector; and
providing, addressed to the electronic device, the response vector.

2. The computer system of claim 1, wherein the graph database comprises a vector graph database.

3. The computer system of claim 1, wherein the pretrained neural network comprises a large language model.

4. The computer system of claim 1, wherein the operations comprise updating, in the graph database, the context based at least in part on the input vector and the response vector.

5. The computer system of claim 1, wherein the input vector corresponds to: software code, a portion of a narrative, or a portion of a conversation between an individual and the pretrained neural network.

6. The computer system of claim 1, wherein the predefined value is less than or equal to 8,095 tokens.

7. The computer system of claim 1, wherein the predefined value is significantly smaller than 128,000 tokens.

8. The computer system of claim 1, wherein the dynamic content window corresponds to a next operation in an interaction between the electronic device and the pretrained neural network.

9. The computer system of claim 1, wherein the pretrained neural network is implemented using a second computer system; and
wherein the second computer system is different from the computer system.

10. The computer system of claim 1, wherein the response vector is based at least in part on the input vector and the dynamic content window.

11. The computer system of claim 1, wherein the pretrained neural network comprises one or more convolutional layers, one or more residual layers and one or more dense layers; and
wherein a given node in a given layer in the pretrained neural network comprises an activation function that comprises one or more of: a rectified linear activation function (ReLU), a leaky ReLU, an exponential linear unit (ELU) activation function, a parametric ReLU, a tanh activation function, or a sigmoid activation function.

12. A non-transitory computer-readable storage medium for use in conjunction with a computer system, the computer-readable storage medium storing program instructions that, when executed by the computer system, causes the computer system to perform one or more operations comprising:
receiving, from an electronic device, an input vector;
accessing, in a graph database, information specifying a context associated with the input vector;
determining a dynamic content window based at least in part on the context, wherein the dynamic content window specifies a subset of content in the input vector, and the dynamic content window has a length less than a predefined value;
providing, to a pretrained neural network, the input vector and the dynamic content window;
receiving, from the pretrained neural network, a response vector; and
providing, addressed to the electronic device, the response vector.

13. The non-transitory computer-readable storage medium of claim 12, wherein the graph database comprises a vector graph database.

14. The non-transitory computer-readable storage medium of claim 12, wherein the pretrained neural network comprises a large language model.

15. The non-transitory computer-readable storage medium of claim 12, wherein the operations comprise updating, in the graph database, the context based at least in part on the input vector and the response vector.

16. A method for determining a dynamic content window, comprising:
by a computer system:
receiving, from an electronic device, an input vector;
accessing, in a graph database, information specifying a context associated with the input vector;
determining a dynamic content window based at least in part on the context, wherein the dynamic content window specifies a subset of content in the input vector, and the dynamic content window has a length less than a predefined value;
providing, to a pretrained neural network, the input vector and the dynamic content window;
receiving, from the pretrained neural network, a response vector; and
providing, addressed to the electronic device, the response vector.

17. The method of claim 16, wherein the graph database comprises a vector graph database.

18. The method of claim 16, wherein the pretrained neural network comprises a large language model.

19. The method of claim 16, wherein the operations comprise updating, in the graph database, the context based at least in part on the input vector and the response vector.

20. The method of claim 16, wherein the predefined value is less than or equal to 8,095 tokens.
